(19) United States
(12) Patent Application Publication
(10) Pub. No.: US 2026/0169250 A1
(43) Pub. Date: Jun. 18, 2026

(54) IMAGING LENS ASSEMBLY MODULE, CAMERA MODULE AND ELECTRONIC DEVICE

(71) Applicant: LARGAN PRECISION CO., LTD., Taichung City (TW)

(72) Inventors: Wen-Yu TSAI, Taichung City (TW); Hsiu-Yi HSIAO, Taichung City (TW); Ming-Ta CHOU, Taichung City (TW); Chien-Pang CHANG, Taichung City (TW); Kuo-Chiang CHU, Taichung City (TW)

(21) Appl. No.: 19/403,395

(22) Filed: Nov. 28, 2025

Related U.S. Application Data
(60) Provisional application No. 63/734,228, filed on Dec. 16, 2024.

(51) Int. Cl. G02B 7/02; G02B 1/00; G02B 1/118; G03B 9/20; H04N 23/55

(52) U.S. Cl. CPC G02B 7/021; G02B 1/002; G02B 1/118; G03B 9/20; H04N 23/55

(57) ABSTRACT

An imaging lens assembly module includes at least one lens element and a barrel. The at least one lens element has a central axis. The at least one lens element is accommodated in the barrel, and the barrel includes a low reflective cluster layer disposed on a surface of the barrel. A composition of the low reflective cluster layer includes a metallic element and a fluorine.

### RELATED APPLICATIONS

This application claims priority to U.S. Provisional Application Ser. No. 63/734,228, filed Dec. 16, 2024, which is herein incorporated by reference.

### BACKGROUND

### Technical Field

The present disclosure relates to an imaging lens assembly module and a camera module. More particularly, the present disclosure relates to an imaging lens assembly module and a camera module applicable to portable electronic devices.

### Description of Related Art

In the recent years, portable electronic devices have developed rapidly. For example, intelligent electronic devices and tablets have been filled in the lives of modern people, and camera modules and imaging lens assembly modules mounted on portable electronic devices have also prospered. However, as technology advances, the quality requirements of imaging lens assembly modules are becoming higher and higher. Therefore, an imaging lens assembly module, which is beneficial for reducing the intensity of the reflected light and improving the image quality, needs to be developed.

### SUMMARY

According to one aspect of the present disclosure, an imaging lens assembly module includes at least one lens element and a barrel. The at least one lens element has a central axis. The at least one lens element is accommodated in the barrel, and the barrel includes a low reflective cluster layer disposed on a surface of the barrel. A composition of the low reflective cluster layer includes a metallic element and a fluorine. When an average particle size of the low reflective cluster layer is φavg, a reflectance of the low reflective cluster layer at a wavelength of 550 nm is R55, and a reflectance of the low reflective cluster layer at a wavelength of 700 nm is R70, the following conditions are satisfied: 20 nm≤φavg≤180 nm; R55≤0.25%; and R70≤0.25%.

According to one aspect of the present disclosure, an imaging lens assembly module includes at least one optical element and a light-blocking element. The light-blocking element is disposed corresponding to the at least one optical element, and the light-blocking element includes a low reflective cluster layer disposed on a surface of the light-blocking element. A composition of the low reflective cluster layer includes a metallic element and a fluorine. When an average particle size of the low reflective cluster layer is φavg, a reflectance of the low reflective cluster layer at a wavelength of 550 nm is R55, and a reflectance of the low reflective cluster layer at a wavelength of 700 nm is R70, the following conditions are satisfied: 20 nm≤φavg≤180 nm; R55≤ 0.25%; and R70≤0.25%.

According to one aspect of the present disclosure, an imaging lens assembly module includes at least one optical element and a light-blocking element. The light-blocking element is disposed corresponding to the at least one optical element, and the light-blocking element includes a low reflective cluster layer disposed on a surface of the light-blocking element. A composition of the low reflective cluster layer includes a metallic element and an oxygen. When an average particle size of the low reflective cluster layer is φavg, a reflectance of the low reflective cluster layer at a wavelength of 550 nm is R55, and a reflectance of the low reflective cluster layer at a wavelength of 700 nm is R70, the following conditions are satisfied: 20 nm≤φavg≤180 nm; R55≤ 0.25%; and R70≤0.25%.

According to one aspect of the present disclosure, a camera module includes the imaging lens assembly module of the aforementioned aspect.

According to one aspect of the present disclosure, an electronic device includes the camera module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging lens assembly module according to the 1st Embodiment of the present disclosure.

FIG. 1B is an exploded view of the imaging lens assembly module according to the 1st Embodiment in FIG. 1A.

FIG. 1C is a scanning electron microscope image of area 1C of a low reflective cluster layer according to the 1st Example of the 1st Embodiment in FIG. 1B.

FIG. 1D is an energy dispersive X-ray spectroscope diagram of area 1C of the low reflective cluster layer according to the 1st Example of the 1st Embodiment in FIG. 1B.

FIG. 1E is a scanning electron microscope image of area 1E of a low reflective cluster layer according to the 2nd Example of the 1st Embodiment in FIG. 1B.

FIG. 1F is an energy dispersive X-ray spectroscope diagram of area 1E of the low reflective cluster layer according to the 2nd Example of the 1st Embodiment in FIG. 1B.

FIG. 1G is a reflectance diagram of the low reflective cluster layers according to the 1st Example and the 2nd Example of the 1st Embodiment in FIG. 1B.

FIG. 2A is a schematic view of an imaging lens assembly module according to the 2nd Embodiment of the present disclosure.

FIG. 2B is an exploded view of the imaging lens assembly module according to the 2nd Embodiment in FIG. 2A.

FIG. 3A is a schematic view of an imaging lens assembly module according to the 3rd Embodiment of the present disclosure.

FIG. 3B is an exploded view of the imaging lens assembly module according to the 3rd Embodiment in FIG. 3A.

FIG. 4A is a schematic view of an imaging lens assembly module according to the 4th Embodiment of the present disclosure.

FIG. 4B is an exploded view of the imaging lens assembly module according to the 4th Embodiment in FIG. 4A.

FIG. 4C is another exploded view of the imaging lens assembly module according to the 4th Embodiment in FIG. 4A.

FIG. 5A is a schematic view of an electronic device according to the 5th Embodiment of the present disclosure.

FIG. 5B is another schematic view of the electronic device according to the 5th Embodiment in FIG. 5A.

FIG. 5C is a schematic view of an image captured via the electronic device according to the 5th Embodiment in FIG. 5A.

FIG. 5D is a schematic view of another image captured via the electronic device according to the 5th Embodiment in FIG. 5A.

FIG. 5E is a schematic view of another image captured via the electronic device according to the 5th Embodiment in FIG. 5A.

FIG. 6 is a schematic view of an electronic device according to the 6th Embodiment of the present disclosure.

FIG. 7A is a schematic view of an electronic device configured on a vehicle according to the 7th Embodiment of the present disclosure.

FIG. 7B is another schematic view of the electronic device configured on the vehicle according to the 7th Embodiment in FIG. 7A.

FIG. 7C is another schematic view of the electronic device configured on the vehicle according to the 7th Embodiment in FIG. 7A.

FIG. 8 is a schematic view of an electronic device applied to an unmanned aerial vehicle according to the 8th Embodiment of the present disclosure.

### DETAILED DESCRIPTION

An embodiment of the present disclosure provides an imaging lens assembly module, which includes at least one lens element and a barrel, the at least one lens element has a central axis, and the at least one lens element is accommodated in the barrel. The barrel includes a low reflective cluster layer, and the low reflective cluster layer is disposed on a surface of the barrel. A composition of the low reflective cluster layer includes a metallic element and a fluorine, when an average particle size of the low reflective cluster layer is φavg, a reflectance of the low reflective cluster layer at a wavelength of 550 nm is R55, and a reflectance of the low reflective cluster layer at a wavelength of 700 nm is R70, the following conditions are satisfied: 20 nm≤φavg≤180 nm; R55≤ 0.25%; and R70≤0.25%. Therefore, when the average particle size satisfies the specific condition, it is favorable for the nanoparticles stacking to form a gradient refractive index so as to reduce the intensity of the reflected light on the low reflective cluster layer. Moreover, setting a better reflectance range is beneficial to improve the imaging quality. Further, when the average particle size of the low reflective cluster layer is φavg, the following condition can be satisfied: 50 nm≤φavg≤170 nm. Specifically, the low reflective cluster layer can be so-called anti reflective (AR) cluster layer, but is not limited thereto.

Furthermore, when an average reflectance of the low reflective cluster layer within a wavelength range of 400 nm to 500 nm is R4050, the following condition can be satisfied: R4050≤0.25%. The low reflectance is kept within the wavelength range of 400 nm to 500 nm, and it is favorable for reducing the stray light within a wavelength range of the blue light so as to improve the imaging quality. Further, when the average reflectance of the low reflective cluster layer within the wavelength range of 400 nm to 500 nm is R4050, the following condition can be satisfied: R4050≤0.13%.

Moreover, when the reflectance of the low reflective cluster layer at the wavelength of 550 nm is R55, and the reflectance of the low reflective cluster layer at the wavelength of 700 nm is R70, the following conditions can be satisfied: R55≤0.13%; and R70≤0.13%. Therefore, setting a better reflectance range is beneficial to improve the imaging quality. Further, when the reflectance of the low reflective cluster layer at the wavelength of 550 nm is R55, and the reflectance of the low reflective cluster layer at the wavelength of 700 nm is R70, the following conditions can be satisfied: R55≤0.07%; and R70≤0.07%.

The composition of the low reflective cluster layer can further include a carbon and a metal fluoride. Therefore, it is favorable for forming the gradient refractive index. In detail, the low reflective cluster layer includes carbon, so that the appearance of the low reflective cluster layer is black. Further, the low reflective cluster layer includes the metal fluoride, so as to form the cluster structure, and the undulating surface morphology of the cluster structure is beneficial to form the gradient refractive index. Further, the composition of the low reflective cluster layer can further include magnesium fluoride.

Moreover, the composition of the low reflective cluster layer can further include a silicon. In detail, it can be considered that the composition of the low reflective cluster layer includes a silicon compound, such as SiO₂, SiC, etc., but is not limited to the listed compounds. Furthermore, the composition of the low reflective cluster layer can further include silicon dioxide. Therefore, it is beneficial to prevent the low reflective cluster layer from being oxidated so as to improve the durability of the imaging lens assembly module.

Another embodiment of the present disclosure provides an imaging lens assembly module, which includes at least one optical element and a light-blocking element, and the light-blocking element is disposed corresponding to the at least one optical element. The light-blocking element includes a low reflective cluster layer, and the low reflective cluster layer is disposed on a surface of the light-blocking element. A composition of the low reflective cluster layer includes a metallic element, when an average particle size of the low reflective cluster layer is φavg, a reflectance of the low reflective cluster layer at a wavelength of 550 nm is R55, and a reflectance of the low reflective cluster layer at a wavelength of 700 nm is R70, the following conditions are satisfied: 20 nm≤φavg≤180 nm; R55≤0.25%; and R70≤0.25%. Therefore, when the average particle size satisfies the specific condition, it is favorable for the nanoparticles stacking to form a gradient refractive index so as to reduce the intensity of the reflected light on the low reflective cluster layer. Moreover, setting a better reflectance range is beneficial to improve the imaging quality. Further, when the average particle size of the low reflective cluster layer is φavg, the following condition can be satisfied: 50 nm≤φavg≤170 nm.

Specifically, the optical element can be a lens element, an imaging lens assembly, a light folding element or a prism, etc., and the optical element can be a plastic element or a metal element, but is not limited thereto. Moreover, the light-blocking element can be a barrel, a lens carrier, a retainer, a light blocking member, a spacer, a case, a variable aperture blade, a fixed aperture element, a cap or a lens holder, etc., but is not limited thereto.

Furthermore, when an average reflectance of the low reflective cluster layer within a wavelength range of 400 nm to 500 nm is R4050, the following condition can be satisfied: R4050≤0.25%. The low reflectance is kept within the wavelength range of 400 nm to 500 nm, and it is favorable for reducing the stray light within a wavelength range of the blue light so as to improve the imaging quality. Further, when the average reflectance of the low reflective cluster layer within the wavelength range of 400 nm to 500 nm is R4050, the following condition can be satisfied: R4050≤0.13%.

Moreover, when the reflectance of the low reflective cluster layer at the wavelength of 550 nm is R55, and the reflectance of the low reflective cluster layer at the wavelength of 700 nm is R70, the following conditions can be satisfied: R55≤0.13%; and R70≤0.13%. Therefore, setting a better reflectance range is beneficial to improve the imaging quality. Further, when the reflectance of the low reflective cluster layer at the wavelength of 550 nm is R55, and the reflectance of the low reflective cluster layer at the wavelength of 700 nm is R70, the following conditions can be satisfied: R55≤0.07%; and R70≤0.07%.

The composition of the low reflective cluster layer can further include a fluorine, and the composition of the low reflective cluster layer can further include a carbon and a metal fluoride. Therefore, it is favorable for forming the gradient refractive index. In detail, the low reflective cluster layer includes carbon, so that the appearance of the low reflective cluster layer is black. Further, the low reflective cluster layer includes the metal fluoride, so as to form the cluster structure, and the undulating surface morphology of the cluster structure is beneficial to form the gradient refractive index.

Specifically, the composition of the low reflective cluster layer includes the metallic element and the fluorine, which can be regarded as including the metal fluoride, but is not limited thereto, wherein the metal fluoride can be MgF₂, AlF₃, BaF₂, Na₃AlF₆, Na₅Al₃F₁₄, YF₃, etc., but is not limited to the listed compounds. In detail, the composition of the low reflective cluster layer includes magnesium fluoride.

Moreover, the composition of the low reflective cluster layer can include an oxygen, and the composition of the low reflective cluster layer can further include a carbon and a metal oxide. Therefore, it is favorable for forming the gradient refractive index. In detail, the low reflective cluster layer includes carbon, so that the appearance of the low reflective cluster layer is black. Further, the low reflective cluster layer includes the metal oxide, so as to form the cluster structure, and the undulating surface morphology of the cluster structure is beneficial to form the gradient refractive index.

Specifically, the composition of the low reflective cluster layer includes the metallic element and the oxygen, which can be regarded as including the metal oxide, but is not limited thereto, wherein the metal oxide can be Al₂O₃, Cr₂O₃, Ta₂O₅, SnO₂, Sb₂O₅, CeO₂, Ag₂O, Y₂O₃, ZrO₂, HfO₂, Yb₂O₃, In₂O₃, RuO₂, CuO, FeO, ZnO, BeO, etc., but is not limited to the listed compounds. In detail, the composition of the low reflective cluster layer can include aluminium oxide. Furthermore, the composition of the low reflective cluster layer can include a silicon. In detail, it can be considered that the composition of the low reflective cluster layer includes a silicon compound, such as SiO₂, SiC, etc., but is not limited to the listed compounds. Furthermore, the composition of the low reflective cluster layer can further include silicon dioxide. Therefore, it is beneficial to prevent the low reflective cluster layer from being oxidated so as to improve the durability of the imaging lens assembly module.

In detail, nanocluster structures of the low reflective cluster layer can be observed via the scanning electron microscope (SEM) or the transmission electron microscope (TEM), and the presence of the metallic element and fluorine or oxygen can be proven via the energy dispersive X-ray spectroscope (EDS) of the scanning electron microscope or the transmission electron microscope. Further, fluorine is analyzed by the energy dispersive X-ray spectroscope, and the signal of fluorine in the metal fluoride is easily detected, but is not limited thereto.

Each of the aforementioned features of the imaging lens assembly module can be utilized in various combinations for achieving the corresponding effects.

The present disclosure provides a camera module that includes the aforementioned imaging lens assembly module.

The present disclosure provides an electronic device that includes the aforementioned camera module.

According to the aforementioned descriptions, specific embodiments and specific examples are provided, and illustrated via figures.

### 1st Embodiment

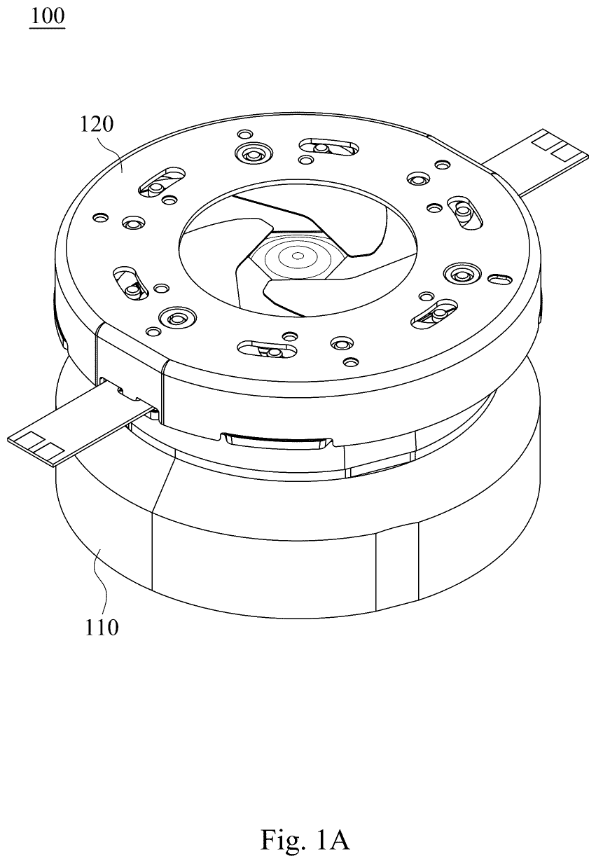

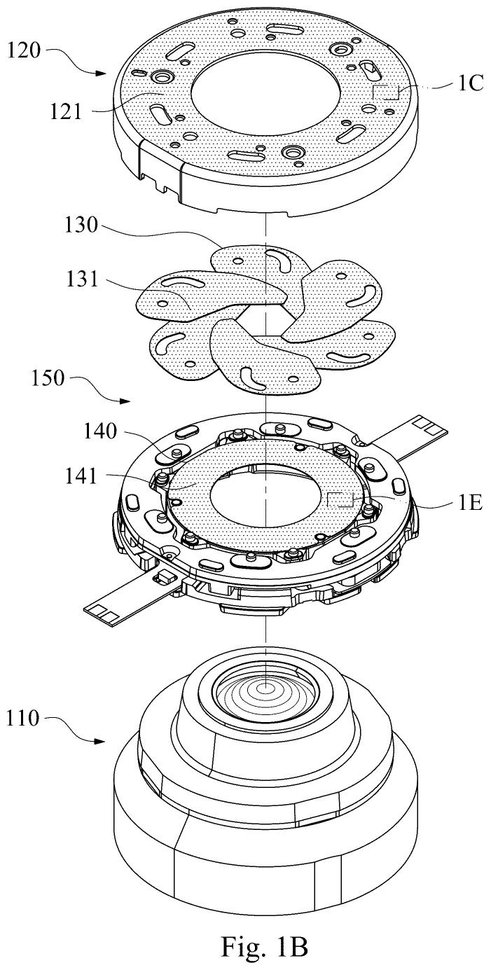

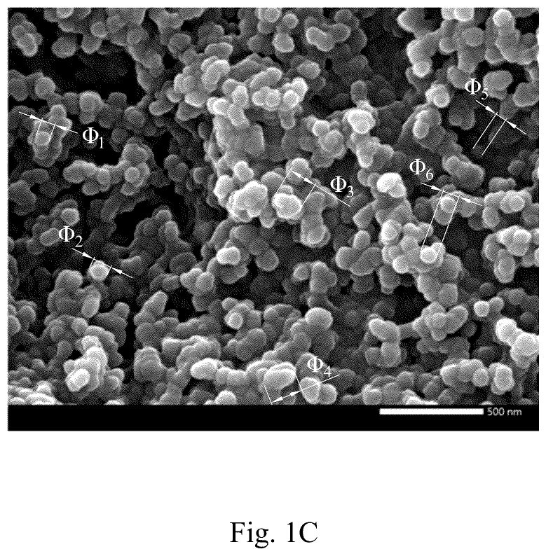

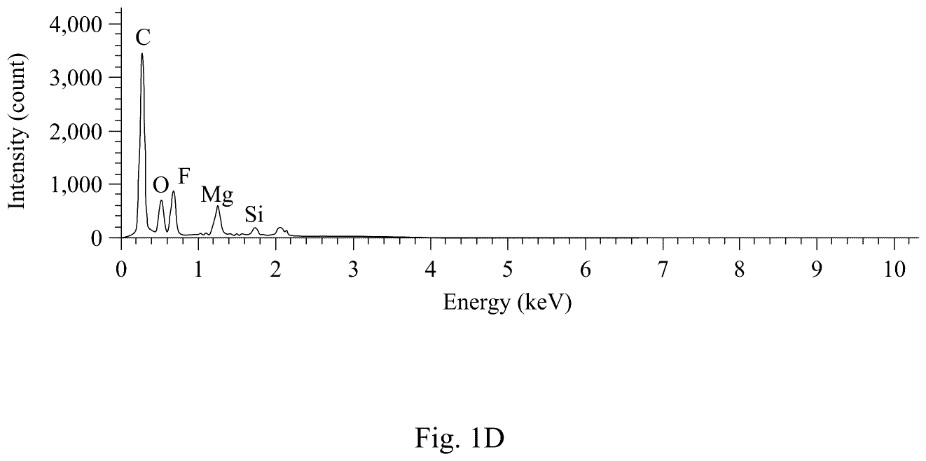

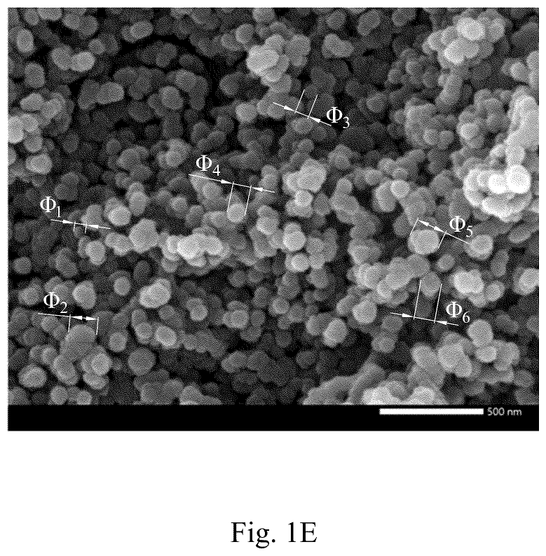

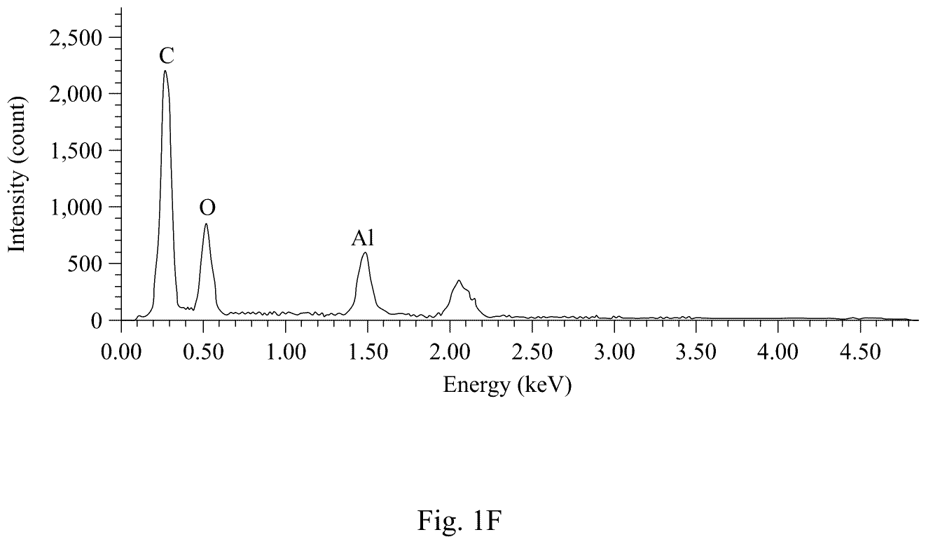

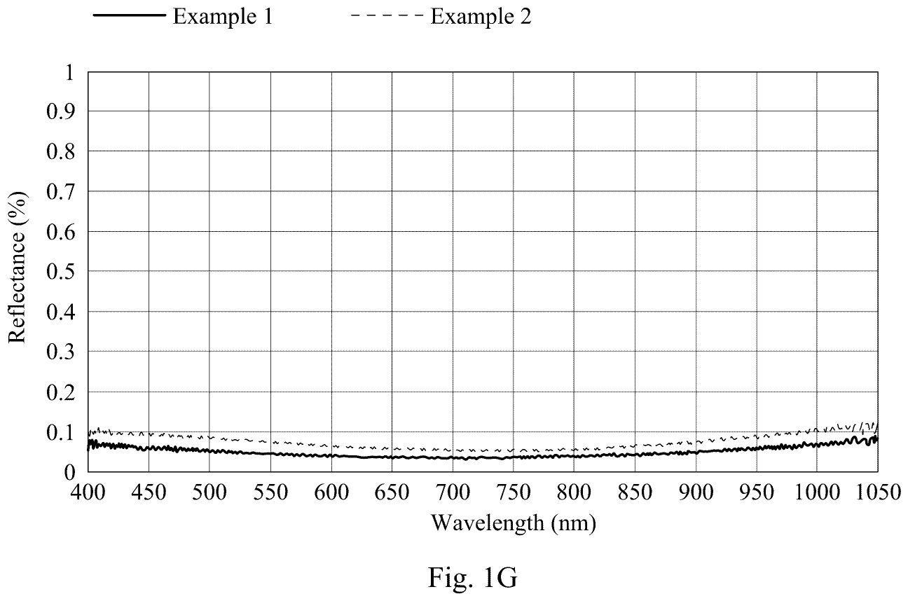

FIG. 1A is a schematic view of an imaging lens assembly module 100 according to the 1st Embodiment of the present disclosure, and FIG. 1B is an exploded view of the imaging lens assembly module 100 according to the 1st Embodiment in FIG. 1A. In FIG. 1A and FIG. 1B, the imaging lens assembly module 100 includes an optical element 110 and three light-blocking elements 120, 130, 140, and the light-blocking element 140 is disposed corresponding to the optical element 110. The light-blocking elements 120, 130, 140 respectively include low reflective cluster layers 121, 131, 141, and the low reflective cluster layers 121, 131, 141 are respectively disposed on surfaces (its reference numeral is omitted) of the light-blocking elements 120, 130, 140. In detail, the imaging lens assembly module 100 can further include a driving portion 150, the light-blocking elements 120, 130, 140, the driving portion 150 and the optical element 110 are arranged in order. Specifically, the light-blocking element 120 can be an upper cover so as to fix the light-blocking elements 130, 140 and the driving portion 150 to the optical element 110, the light-blocking element 130 can be a movable blade disposed corresponding to the driving portion 150, the light-blocking element 140 can be a fixing hole element, and the driving portion 150 is configured to drive the light-blocking element 130, but the present disclosure is not limited thereto. Further, a light-blocking structure is formed by sequentially and correspondingly disposing the light-blocking elements 120, 130, 140 so as to correspond the optical element 110.

FIG. 1C is a scanning electron microscope image of area 1C of a low reflective cluster layer 121 according to the 1st Example of the 1st Embodiment in FIG. 1B, and FIG. 1D is an energy dispersive X-ray spectroscope diagram of area 1C of the low reflective cluster layer 121 according to the 1st Example of the 1st Embodiment in FIG. 1B. In FIG. 1B to FIG. 1D, a composition of the low reflective cluster layer 121 includes a metallic element and a fluorine. Moreover, the composition of the low reflective cluster layer 121 can further include a carbon and a metal fluoride, and the composition of the low reflective cluster layer 121 can further include a silicon. In detail, the composition of the low reflective cluster layer 121 can further include silicon dioxide, and the composition of the low reflective cluster layer 121 can further include magnesium fluoride.

In FIG. 1C, the particle sizes of the low reflective cluster layer 121 at six measuring points in area 1C of the light-blocking element 120 of the 1st Example are respectively φ1=66.94 nm, φ2=91.08 nm, φ3=138.69 nm, φ4=159.69 nm, φ5=54.59 nm and φ6=81.58 nm, the particle sizes of the aforementioned six measuring points are averaged so as to obtain an average particle size of the low reflective cluster layer 121, the average particle size φavg=98.76 nm. In FIG. 1D, the composition of the low reflective cluster layer 121 of the light-blocking element 120 of the 1st Example includes carbon, oxygen, fluorine, magnesium and silicon. It can prove that the composition of the low reflective cluster layer 121 can include silicon dioxide and magnesium fluoride.

FIG. 1E is a scanning electron microscope image of area 1E of a low reflective cluster layer 141 according to the 2nd Example of the 1st Embodiment in FIG. 1B, and FIG. 1F is an energy dispersive X-ray spectroscope diagram of area 1E of the low reflective cluster layer 141 according to the 2nd Example of the 1st Embodiment in FIG. 1B. In FIG. 1B, FIG. 1E and FIG. 1F, a composition of the low reflective cluster layer 141 includes a metallic element and an oxygen. Moreover, the composition of the low reflective cluster layer 141 can further include a carbon and a metal oxide. In detail, the composition of the low reflective cluster layer 141 can include aluminium oxide.

In FIG. 1E, the particle sizes of the low reflective cluster layer 141 at six measuring points in area 1E of the light-blocking element 140 of the 2nd Example are respectively φ1=56.2 nm, φ2=135.63 nm, φ3=67.42 nm, φ4=86.58 nm, φ5=149.4 nm and φ6=100.5 nm, the particle sizes of the aforementioned six measuring points are averaged so as to obtain an average particle size of the low reflective cluster layer 141, the average particle size φavg=99.29 nm. In FIG. 1F, the composition of the low reflective cluster layer 141 of the light-blocking element 140 of the 2nd Example includes carbon, oxygen and aluminium. It can prove that the composition of the low reflective cluster layer 141 can include aluminium oxide.

FIG. 1G is a reflectance diagram of the low reflective cluster layers 121, 141 according to the 1st Example and the 2nd Example of the 1st Embodiment in FIG. 1B. In FIG. 1G, when a reflectance of one of the low reflective cluster layers 121, 141 according to the 1st Example and the 2nd Example at the wavelength of 700 nm is R70, a reflectance of one of the low reflective cluster layers 121, 141 at the wavelength of 550 nm is R55, and an average reflectance of one of the low reflective cluster layers 121, 141 within a wavelength range of 400 nm to 500 nm is R4050, and the parameters satisfy the conditions in Table 1.

TABLE 1

| | 1st Example | 2nd Example |
|---|---|---|
| R70 | 0.0356% | 0.0546% |
| R55 | 0.0461% | 0.0741% |
| R4050 | 0.0609% | 0.0928% |

In detail, the reflectance and the corresponding wavelength values of the 1st Example and the 2nd Example in FIG. 1G are listed in Table 2.

TABLE 2

| | reflectance (%) | |
|---|---|---|
| wavelength | 1st | 2nd |
| (nm) | Example | Example |
| 380 | 0.0956 | 0.0888 |
| 381 | 0.0446 | 0.1056 |
| 382 | 0.0969 | 0.0882 |
| 383 | 0.0652 | 0.1153 |
| 384 | 0.0626 | 0.1006 |
| 385 | 0.0601 | 0.1125 |
| 386 | 0.0573 | 0.0811 |
| 387 | 0.0555 | 0.0947 |
| 388 | 0.0686 | 0.1144 |
| 389 | 0.0774 | 0.0988 |
| 390 | 0.0962 | 0.1126 |
| 391 | 0.0478 | 0.0989 |
| 392 | 0.0585 | 0.1002 |
| 393 | 0.0841 | 0.1168 |
| 394 | 0.0647 | 0.1087 |
| 395 | 0.0624 | 0.0933 |
| 396 | 0.0604 | 0.1013 |
| 397 | 0.0733 | 0.1017 |
| 398 | 0.0758 | 0.1012 |
| 399 | 0.0555 | 0.102 |
| 400 | 0.0537 | 0.0922 |
| 401 | 0.0774 | 0.0892 |
| 402 | 0.0691 | 0.111 |
| 403 | 0.0795 | 0.1026 |
| 404 | 0.0575 | 0.0935 |
| 405 | 0.0688 | 0.1013 |
| 406 | 0.0767 | 0.0902 |
| 407 | 0.06 | 0.1007 |
| 408 | 0.0702 | 0.1105 |
| 409 | 0.0662 | 0.093 |
| 410 | 0.0672 | 0.0991 |
| 411 | 0.0685 | 0.1039 |
| 412 | 0.0722 | 0.1003 |
| 413 | 0.0699 | 0.0969 |
| 414 | 0.0615 | 0.1011 |
| 415 | 0.0693 | 0.0929 |
| 416 | 0.0666 | 0.1037 |
| 417 | 0.0704 | 0.0994 |
| 418 | 0.063 | 0.0943 |
| 419 | 0.0597 | 0.0929 |
| 420 | 0.069 | 0.1011 |
| 421 | 0.0671 | 0.1025 |
| 422 | 0.0606 | 0.0985 |
| 423 | 0.0663 | 0.095 |
| 424 | 0.0638 | 0.0945 |
| 425 | 0.0694 | 0.098 |
| 426 | 0.0622 | 0.0957 |
| 427 | 0.0706 | 0.0941 |
| 428 | 0.0634 | 0.0949 |
| 429 | 0.0661 | 0.0991 |
| 430 | 0.0688 | 0.094 |
| 431 | 0.0681 | 0.096 |
| 432 | 0.0615 | 0.0938 |
| 433 | 0.0671 | 0.0947 |
| 434 | 0.0643 | 0.098 |
| 435 | 0.0666 | 0.0962 |
| 436 | 0.064 | 0.0928 |
| 437 | 0.061 | 0.0921 |
| 438 | 0.0627 | 0.0957 |
| 439 | 0.0617 | 0.0948 |
| 440 | 0.0607 | 0.0938 |
| 441 | 0.0598 | 0.0903 |
| 442 | 0.0592 | 0.0923 |
| 443 | 0.0634 | 0.0986 |
| 444 | 0.0583 | 0.0936 |
| 445 | 0.0579 | 0.0914 |
| 446 | 0.0575 | 0.0913 |
| 447 | 0.0575 | 0.095 |
| 448 | 0.0621 | 0.095 |
| 449 | 0.0619 | 0.0924 |
| 450 | 0.0584 | 0.0953 |
| 451 | 0.0618 | 0.0918 |
| 452 | 0.063 | 0.0938 |
| 453 | 0.0643 | 0.0931 |
| 454 | 0.0583 | 0.0923 |
| 455 | 0.0572 | 0.0925 |
| 456 | 0.0583 | 0.0925 |
| 457 | 0.0619 | 0.0955 |
| 458 | 0.0583 | 0.0926 |
| 459 | 0.0569 | 0.0897 |
| 460 | 0.0568 | 0.0924 |
| 461 | 0.0591 | 0.0922 |
| 462 | 0.0612 | 0.0957 |
| 463 | 0.0609 | 0.0905 |
| 464 | 0.0572 | 0.0873 |
| 465 | 0.0626 | 0.0896 |
| 466 | 0.0574 | 0.0934 |
| 467 | 0.0592 | 0.089 |
| 468 | 0.0575 | 0.0882 |
| 469 | 0.056 | 0.0927 |
| 470 | 0.0574 | 0.0897 |
| 471 | 0.061 | 0.0918 |
| 472 | 0.0547 | 0.0905 |
| 473 | 0.0531 | 0.0864 |
| 474 | 0.0574 | 0.091 |
| 475 | 0.0577 | 0.0894 |
| 476 | 0.0606 | 0.0896 |
| 477 | 0.0554 | 0.0872 |
| 478 | 0.0541 | 0.0854 |
| 479 | 0.0579 | 0.09 |
| 480 | 0.0546 | 0.0888 |
| 481 | 0.0566 | 0.0876 |
| 482 | 0.0559 | 0.0893 |
| 483 | 0.0553 | 0.0871 |
| 484 | 0.0558 | 0.0899 |
| 485 | 0.0576 | 0.0865 |
| 486 | 0.054 | 0.085 |
| 487 | 0.0561 | 0.0873 |
| 488 | 0.0554 | \|0.0879 |
| 489 | 0.0565 | 0.0888 |
| 490 | 0.0544 | 0.0878 |
| 491 | 0.0529 | 0.0848 |
| 492 | 0.0522 | 0.0852 |
| 493 | 0.0532 | 0.0879 |
| 494 | 0.0537 | 0.0851 |
| 495 | 0.0557 | 0.086 |
| 496 | 0.0519 | 0.0845 |
| 497 | 0.0528 | 0.085 |
| 498 | 0.0555 | 0.0883 |
| 499 | 0.0522 | 0.0847 |
| 500 | 0.0521 | 0.0832 |
| 501 | 0.0531 | 0.0834 |
| 502 | 0.0543 | 0.0866 |
| 503 | 0.0538 | 0.0855 |
| 504 | 0.0528 | 0.0852 |
| 505 | 0.0517 | 0.0835 |
| 506 | 0.0528 | 0.0839 |
| 507 | 0.0523 | 0.0835 |
| 508 | 0.052 | 0.0843 |
| 509 | 0.051 | 0.0826 |
| 510 | 0.053 | 0.0812 |
| 511 | 0.0526 | 0.0833 |
| 512 | 0.0515 | 0.0817 |
| 513 | 0.0517 | 0.0807 |
| 514 | 0.0496 | 0.0811 |
| 515 | 0.0522 | 0.0805 |
| 516 | 0.05 | 0.0819 |
| 517 | 0.0514 | 0.0822 |
| 518 | 0.0511 | 0.0794 |
| 519 | 0.0485 | 0.0802 |
| 520 | 0.0502 | 0.0805 |
| 521 | 0.0491 | 0.0802 |
| 522 | 0.0488 | 0.0803 |
| 523 | 0.0481 | 0.0788 |
| 524 | 0.0494 | 0.0798 |
| 525 | 0.0506 | 0.0811 |
| 526 | 0.0489 | 0.0776 |
| 527 | 0.0495 | 0.0791 |
| 528 | 0.0487 | 0.0786 |
| 529 | 0.0489 | 0.0796 |
| 530 | 0.0502 | 0.0791 |
| 531 | 0.0481 | 0.0792 |
| 532 | 0.048 | 0.0774 |
| 533 | 0.0484 | 0.0779 |
| 534 | 0.0491 | 0.0783 |
| 535 | 0.0477 | 0.0779 |
| 536 | 0.0491 | 0.0785 |
| 537 | 0.0486 | 0.0771 |
| 538 | 0.0487 | 0.0767 |
| 539 | 0.0482 | 0.078 |
| 540 | 0.0473 | 0.0766 |
| 541 | 0.0469 | 0.0757 |
| 542 | 0.0471 | 0.0756 |
| 543 | 0.0467 | 0.0765 |
| 544 | 0.047 | 0.0754 |
| 545 | 0.0466 | 0.0759 |
| 546 | 0.0458 | 0.0747 |
| 547 | 0.047 | 0.0751 |
| 548 | 0.0473 | 0.0754 |
| 549 | 0.047 | 0.0754 |
| 550 | 0.0461 | 0.0741 |
| 551 | 0.0457 | 0.0744 |
| 552 | 0.0455 | 0.0742 |
| 553 | 0.0454 | 0.0738 |
| 554 | 0.0453 | 0.0746 |
| 555 | 0.0451 | 0.0727 |
| 556 | 0.0455 | 0.0739 |
| 557 | 0.0457 | 0.0748 |
| 558 | 0.046 | 0.0737 |
| 559 | 0.045 | 0.0721 |
| 560 | 0.0449 | 0.0724 |
| 561 | 0.0449 | 0.0728 |
| 562 | 0.0458 | 0.0731 |
| 563 | 0.0461 | 0.0719 |
| 564 | 0.0446 | 0.0713 |
| 565 | 0.0436 | 0.0722 |
| 566 | 0.0436 | 0.0726 |
| 567 | 0.0448 | 0.0709 |
| 568 | 0.0437 | 0.0714 |
| 569 | 0.0437 | 0.071 |
| 570 | 0.0438 | 0.0702 |
| 571 | 0.0439 | 0.0714 |
| 572 | 0.0438 | 0.0707 |
| 573 | 0.0427 | 0.0696 |
| 574 | 0.0428 | 0.0708 |
| 575 | 0.0449 | 0.0707 |
| 576 | 0.0442 | 0.0695 |
| 577 | 0.0435 | 0.0696 |
| 578 | 0.0423 | 0.0692 |
| 579 | 0.0421 | 0.0673 |
| 580 | 0.043 | 0.0705 |
| 581 | 0.0429 | 0.0696 |
| 582 | 0.0434 | 0.0678 |
| 583 | 0.0436 | 0.0694 |
| 584 | 0.0411 | 0.0677 |
| 585 | 0.0438 | 0.0674 |
| 586 | 0.0424 | 0.0684 |
| 587 | 0.0423 | 0.0674 |
| 588 | 0.043 | 0.0671 |
| 589 | 0.0418 | 0.0681 |
| 590 | 0.0417 | 0.0675 |
| 591 | 0.0416 | 0.0654 |
| 592 | 0.0416 | 0.0662 |
| 593 | 0.0415 | 0.066 |
| 594 | 0.0418 | 0.0666 |
| 595 | 0.042 | 0.0666 |
| 596 | 0.0404 | 0.0645 |
| 597 | 0.0401 | 0.0656 |
| 598 | 0.0423 | 0.066 |
| 599 | 0.0413 | 0.0646 |
| 600 | 0.0403 | 0.0648 |
| 601 | 0.0411 | 0.0652 |
| 602 | 0.0414 | 0.0645 |
| 603 | 0.0412 | 0.0654 |
| 604 | 0.0405 | 0.066 |
| 605 | 0.0408 | 0.0639 |
| 606 | 0.0395 | 0.0643 |
| 607 | 0.0409 | 0.0644 |
| 608 | 0.04 | 0.0632 |
| 609 | 0.0409 | 0.0634 |
| 610 | 0.0398 | 0.0624 |
| 611 | 0.0396 | 0.0629 |
| 612 | 0.0394 | 0.0638 |
| 613 | 0.0392 | 0.0631 |
| 614 | 0.039 | 0.0615 |
| 615 | 0.0389 | 0.0625 |
| 616 | 0.0388 | 0.0625 |
| 617 | 0.0396 | 0.0619 |
| 618 | 0.0398 | 0.0632 |
| 619 | 0.0395 | 0.0606 |
| 620 | 0.0386 | 0.0609 |
| 621 | 0.0394 | 0.0619 |
| 622 | 0.0388 | 0.0615 |
| 623 | 0.0388 | 0.0604 |
| 624 | 0.0389 | 0.0613 |
| 625 | 0.0391 | 0.0598 |
| 626 | 0.0382 | 0.0613 |
| 627 | 0.0383 | 0.0614 |
| 628 | 0.038 | 0.0594 |
| 629 | 0.0382 | 0.06 |
| 630 | 0.0389 | 0.0607 |
| 631 | 0.0379 | 0.0598 |
| 632 | 0.0381 | 0.0599 |
| 633 | 0.0377 | 0.0599 |
| 634 | 0.0384 | 0.0589 |
| 635 | 0.0376 | 0.0607 |
| 636 | 0.0388 | 0.0594 |
| 637 | 0.038 | 0.0584 |
| 638 | 0.0382 | 0.0587 |
| 639 | 0.0385 | 0.0591 |
| 640 | 0.0377 | 0.0594 |
| 641 | 0.0384 | 0.0585 |
| 642 | 0.0369 | 0.0578 |
| 643 | 0.0367 | 0.0588 |
| 644 | 0.0381 | 0.0605 |
| 645 | 0.0371 | 0.0586 |
| 646 | 0.0365 | 0.0581 |
| 647 | 0.0373 | 0.0592 |
| 648 | 0.0365 | 0.0575 |
| 649 | 0.0374 | 0.0585 |
| 650 | 0.0374 | 0.059 |
| 651 | 0.037 | 0.0574 |
| 652 | 0.0369 | 0.0575 |
| 653 | 0.0369 | 0.0588 |
| 654 | 0.037 | 0.058 |
| 655 | 0.0371 | 0.0584 |
| 656 | 0.0371 | 0.0571 |
| 657 | 0.0376 | 0.0581 |
| 658 | 0.0381 | 0.0583 |
| 659 | 0.0374 | 0.0579 |
| 660 | 0.0375 | 0.0565 |
| 661 | 0.037 | 0.0575 |
| 662 | 0.0353 | 0.0587 |
| 663 | 0.0372 | 0.0574 |
| 664 | 0.0365 | 0.0569 |
| 665 | 0.0364 | 0.0559 |
| 666 | 0.0365 | 0.0562 |
| 667 | 0.0357 | 0.0583 |
| 668 | 0.0377 | 0.0575 |
| 669 | 0.0354 | 0.0552 |
| 670 | 0.0373 | 0.0567 |
| 671 | 0.0376 | 0.057 |
| 672 | 0.0371 | 0.0572 |
| 673 | 0.0357 | 0.0583 |
| 674 | 0.0373 | 0.0558 |
| 675 | 0.0366 | 0.0556 |
| 676 | 0.037 | 0.0581 |
| 677 | 0.0375 | 0.0556 |
| 678 | 0.0363 | 0.0552 |
| 679 | 0.0362 | 0.0573 |
| 680 | 0.0367 | 0.0564 |
| 681 | 0.0363 | 0.0575 |
| 682 | 0.0365 | 0.0565 |
| 683 | 0.0371 | 0.0552 |
| 684 | 0.0353 | 0.0552 |
| 685 | 0.0361 | 0.0571 |
| 686 | 0.0363 | 0.0552 |
| 687 | 0.0363 | 0.0554 |
| 688 | 0.0362 | 0.0563 |
| 689 | 0.0362 | 0.0554 |
| 690 | 0.0362 | 0.0562 |
| 691 | 0.0362 | 0.0569 |
| 692 | 0.0361 | 0.0553 |
| 693 | 0.0349 | 0.0559 |
| 694 | 0.0345 | 0.0569 |
| 695 | 0.036 | 0.0545 |
| 696 | 0.0359 | 0.0555 |
| 697 | 0.0358 | 0.0545 |
| 698 | 0.0357 | 0.0551 |
| 699 | 0.0369 | 0.0563 |
| 700 | 0.0356 | 0.0546 |
| 701 | 0.0355 | 0.0538 |
| 702 | 0.0355 | 0.0549 |
| 703 | 0.0354 | 0.055 |
| 704 | 0.036 | 0.0553 |
| 705 | 0.0359 | 0.0547 |
| 706 | 0.0353 | 0.0536 |
| 707 | 0.0353 | 0.0549 |
| 708 | 0.0357 | 0.0556 |
| 709 | 0.0358 | 0.054 |
| 710 | 0.0363 | 0.0544 |
| 711 | 0.0336 | 0.0546 |
| 712 | 0.035 | 0.0534 |
| 713 | 0.035 | 0.054 |
| 714 | 0.0349 | 0.0546 |
| 715 | 0.0349 | 0.052 |
| 716 | 0.0351 | 0.0547 |
| 717 | 0.0362 | 0.055 |
| 718 | 0.0351 | 0.0534 |
| 719 | 0.0346 | 0.0542 |
| 720 | 0.0359 | 0.0549 |
| 721 | 0.0359 | 0.054 |
| 722 | 0.0358 | 0.0553 |
| 723 | 0.0357 | 0.0541 |
| 724 | 0.0356 | 0.0527 |
| 725 | 0.0355 | 0.0531 |
| 726 | 0.0354 | 0.0537 |
| 727 | 0.0353 | 0.0536 |
| 728 | 0.0352 | 0.0544 |
| 729 | 0.0352 | 0.0523 |
| 730 | 0.0358 | 0.0537 |
| 731 | 0.0364 | 0.0546 |
| 732 | 0.0363 | 0.0544 |
| 733 | 0.0362 | 0.0537 |
| 734 | 0.0355 | 0.0537 |
| 735 | 0.0357 | 0.0532 |
| 736 | 0.0361 | 0.0545 |
| 737 | 0.036 | 0.0548 |
| 738 | 0.0359 | 0.0531 |
| 739 | 0.035 | 0.0541 |
| 740 | 0.0357 | 0.0555 |
| 741 | 0.0358 | 0.0532 |
| 742 | 0.0358 | 0.0532 |
| 743 | 0.0358 | 0.0533 |
| 744 | 0.0358 | 0.0533 |
| 745 | 0.0372 | 0.0549 |
| 746 | 0.0367 | 0.054 |
| 747 | 0.0358 | 0.0523 |
| 748 | 0.0369 | 0.0535 |
| 749 | 0.0358 | 0.0545 |
| 750 | 0.0372 | 0.0542 |
| 751 | 0.0372 | 0.0549 |
| 752 | 0.0371 | 0.0539 |
| 753 | 0.0358 | 0.0531 |
| 754 | 0.0372 | 0.0551 |
| 755 | 0.0372 | 0.0535 |
| 756 | 0.0362 | 0.0528 |
| 757 | 0.0384 | 0.0551 |
| 758 | 0.0363 | 0.0542 |
| 759 | 0.0386 | 0.0551 |
| 760 | 0.0377 | 0.0545 |
| 761 | 0.0372 | 0.0533 |
| 762 | 0.036 | 0.0544 |
| 763 | 0.0372 | 0.0552 |
| 764 | 0.0381 | 0.0546 |
| 765 | 0.0374 | 0.0534 |
| 766 | 0.0371 | 0.055 |
| 767 | 0.0364 | 0.0539 |
| 768 | 0.0373 | 0.0555 |
| 769 | 0.0385 | 0.0546 |
| 770 | 0.0374 | 0.0534 |
| 771 | 0.0387 | 0.054 |
| 772 | 0.0387 | 0.0547 |
| 773 | 0.0375 | 0.0548 |
| 774 | 0.0375 | 0.0549 |
| 775 | 0.0383 | 0.0546 |
| 776 | 0.0382 | 0.0539 |
| 777 | 0.0377 | 0.056 |
| 778 | 0.0375 | 0.0553 |
| 779 | 0.0376 | 0.0542 |
| 780 | 0.0385 | 0.055 |
| 781 | 0.0379 | 0.0558 |
| 782 | 0.0392 | 0.0547 |
| 783 | 0.0393 | 0.0559 |
| 784 | 0.0385 | 0.055 |
| 785 | 0.0381 | 0.0552 |
| 786 | 0.0395 | 0.0576 |
| 787 | 0.0383 | 0.0567 |
| 788 | 0.0393 | 0.0546 |
| 789 | 0.0388 | 0.0556 |
| 790 | 0.0389 | 0.0564 |
| 791 | 0.0398 | 0.0566 |
| 792 | 0.039 | 0.0566 |
| 793 | 0.0392 | 0.0552 |
| 794 | 0.0393 | 0.0547 |
| 795 | 0.0394 | 0.0574 |
| 796 | 0.0404 | 0.0566 |
| 797 | 0.0399 | 0.0564 |
| 798 | 0.0399 | 0.0568 |
| 799 | 0.0401 | 0.0554 |
| 800 | 0.0394 | 0.0567 |
| 801 | 0.0403 | 0.058 |
| 802 | 0.0393 | 0.056 |
| 803 | 0.0404 | 0.056 |
| 804 | 0.0396 | 0.0595 |
| 805 | 0.0398 | 0.0571 |
| 806 | 0.0414 | 0.0581 |
| 807 | 0.0402 | 0.0583 |
| 808 | 0.0404 | 0.0568 |
| 809 | 0.0406 | 0.0586 |
| 810 | 0.0407 | 0.0592 |
| 811 | 0.0409 | 0.0567 |
| 812 | 0.0411 | 0.0587 |
| 813 | 0.0412 | 0.0596 |
| 814 | 0.0414 | 0.0576 |
| 815 | 0.0411 | 0.059 |
| 816 | 0.0401 | 0.0592 |
| 817 | 0.0403 | 0.0581 |
| 818 | 0.0421 | 0.0588 |
| 819 | 0.0407 | 0.0597 |
| 820 | 0.0409 | 0.0579 |
| 821 | 0.0411 | 0.059 |
| 822 | 0.0398 | 0.0597 |
| 823 | 0.0415 | 0.06 |
| 824 | 0.0417 | 0.0613 |
| 825 | 0.0419 | 0.0599 |
| 826 | 0.0408 | 0.0597 |
| 827 | 0.0424 | 0.0616 |
| 828 | 0.0422 | 0.0613 |
| 829 | 0.0412 | 0.0608 |
| 830 | 0.0414 | 0.0612 |
| 831 | 0.0417 | 0.0613 |
| 832 | 0.0437 | 0.061 |
| 833 | 0.0432 | 0.0635 |
| 834 | 0.0424 | 0.06 |
| 835 | 0.0426 | 0.0599 |
| 836 | 0.0428 | 0.0629 |
| 837 | 0.0431 | 0.0646 |
| 838 | 0.0433 | 0.0628 |
| 839 | 0.0435 | 0.0645 |
| 840 | 0.042 | 0.0615 |
| 841 | 0.0422 | 0.0627 |
| 842 | 0.0425 | 0.0653 |
| 843 | 0.044 | 0.0644 |
| 844 | 0.043 | 0.0615 |
| 845 | 0.0431 | 0.0633 |
| 846 | 0.0434 | 0.0648 |
| 847 | 0.0436 | 0.0641 |
| 848 | 0.0438 | 0.0641 |
| 849 | 0.0423 | 0.0634 |
| 850 | 0.0436 | 0.0659 |
| 851 | 0.0436 | 0.0671 |
| 852 | 0.0446 | 0.0654 |
| 853 | 0.0429 | 0.0644 |
| 854 | 0.0436 | 0.0661 |
| 855 | 0.0443 | 0.0664 |
| 856 | 0.0449 | 0.0684 |
| 857 | 0.0456 | 0.0666 |
| 858 | 0.0438 | 0.0654 |
| 859 | 0.0448 | 0.0656 |
| 860 | 0.0449 | 0.0676 |
| 861 | 0.0443 | 0.068 |
| 862 | 0.0463 | 0.067 |
| 863 | 0.0446 | 0.0657 |
| 864 | 0.0448 | 0.0667 |
| 865 | 0.0466 | 0.0707 |
| 866 | 0.0471 | 0.0686 |
| 867 | 0.0468 | 0.0664 |
| 868 | 0.0454 | 0.0684 |
| 869 | 0.0456 | 0.0679 |
| 870 | 0.0457 | 0.0682 |
| 871 | 0.0462 | 0.0693 |
| 872 | 0.0472 | 0.0683 |
| 873 | 0.0461 | 0.0667 |
| 874 | 0.0463 | 0.0724 |
| 875 | 0.0464 | 0.0702 |
| 876 | 0.0466 | 0.069 |
| 877 | 0.0455 | 0.0692 |
| 878 | 0.0464 | 0.0714 |
| 879 | 0.047 | 0.0701 |
| 880 | 0.0471 | 0.0718 |
| 881 | 0.0472 | 0.069 |
| 882 | 0.0474 | 0.07 |
| 883 | 0.0475 | 0.0741 |
| 884 | 0.0495 | 0.0717 |
| 885 | 0.0478 | 0.0719 |
| 886 | 0.048 | 0.0729 |
| 887 | 0.05 | 0.0712 |
| 888 | 0.0464 | 0.074 |
| 889 | 0.0484 | 0.0744 |
| 890 | 0.0486 | 0.0704 |
| 891 | 0.0488 | 0.0719 |
| 892 | 0.0469 | 0.0763 |
| 893 | 0.0508 | 0.0745 |
| 894 | 0.0493 | 0.0725 |
| 895 | 0.0479 | 0.0729 |
| 896 | 0.0496 | 0.0717 |
| 897 | 0.05 | 0.0763 |
| 898 | 0.0502 | 0.0765 |
| 899 | 0.0504 | 0.0723 |
| 900 | 0.0487 | 0.0744 |
| 901 | 0.0488 | 0.0767 |
| 902 | 0.0511 | 0.0758 |
| 903 | 0.0514 | 0.0768 |
| 904 | 0.0516 | 0.0734 |
| 905 | 0.0518 | 0.0764 |
| 906 | 0.0498 | 0.0784 |
| 907 | 0.0501 | 0.0772 |
| 908 | 0.052 | 0.077 |
| 909 | 0.0507 | 0.0756 |
| 910 | 0.0513 | 0.0778 |
| 911 | 0.0536 | 0.0782 |
| 912 | 0.0524 | 0.0805 |
| 913 | 0.0539 | 0.0787 |
| 914 | 0.0521 | 0.0764 |
| 915 | 0.0524 | 0.0799 |
| 916 | 0.0528 | 0.0786 |
| 917 | 0.0531 | 0.0809 |
| 918 | 0.0534 | 0.079 |
| 919 | 0.0538 | 0.0795 |
| 920 | 0.0541 | 0.0799 |
| 921 | 0.0526 | 0.085 |
| 922 | 0.0521 | 0.0806 |
| 923 | 0.0551 | 0.08 |
| 924 | 0.0555 | 0.0818 |
| 925 | 0.0541 | 0.0823 |
| 926 | 0.0535 | 0.0826 |
| 927 | 0.0562 | 0.0822 |
| 928 | 0.0541 | 0.0796 |
| 929 | 0.0544 | 0.0828 |
| 930 | 0.0547 | 0.087 |
| 931 | 0.055 | 0.0826 |
| 932 | 0.0554 | 0.082 |
| 933 | 0.0559 | 0.0831 |
| 934 | 0.0544 | 0.0846 |
| 935 | 0.0566 | 0.0851 |
| 936 | 0.0543 | 0.0846 |
| 937 | 0.0558 | 0.0837 |
| 938 | 0.0579 | 0.0864 |
| 939 | 0.0558 | 0.0874 |
| 940 | 0.0584 | 0.0871 |
| 941 | 0.0561 | 0.0843 |
| 942 | 0.0566 | 0.086 |
| 943 | 0.0594 | 0.0845 |
| 944 | 0.0576 | 0.088 |
| 945 | 0.0596 | 0.0861 |
| 946 | 0.0569 | 0.0858 |
| 947 | 0.059 | 0.0872 |
| 948 | 0.0595 | 0.0909 |
| 949 | 0.0574 | \|0.0893 |
| 950 | 0.0605 | 0.0865 |
| 951 | 0.0591 | 0.0874 |
| 952 | 0.0612 | 0.0911 |
| 953 | 0.0589 | 0.0908 |
| 954 | 0.0584 | 0.0895 |
| 955 | 0.0584 | 0.0879 |
| 956 | 0.0631 | 0.0879 |
| 957 | 0.061 | 0.0919 |
| 958 | 0.0608 | 0.0926 |
| 959 | 0.0604 | 0.0912 |
| 960 | 0.0628 | 0.0883 |
| 961 | 0.0602 | 0.0947 |
| 962 | 0.0635 | 0.0928 |
| 963 | 0.0598 | 0.0938 |
| 964 | 0.0627 | 0.0919 |
| 965 | 0.0598 | 0.0924 |
| 966 | 0.0631 | 0.0944 |
| 967 | 0.0626 | 0.0957 |
| 968 | 0.0607 | 0.0925 |
| 969 | 0.0614 | 0.0929 |
| 970 | 0.066 | 0.0946 |
| 971 | 0.062 | 0.0984 |
| 972 | 0.0596 | 0.0995 |
| 973 | 0.0631 | 0.0938 |
| 974 | 0.0651 | 0.0976 |
| 975 | 0.0619 | 0.0957 |
| 976 | 0.0643 | 0.0967 |
| 977 | 0.065 | 0.098 |
| 978 | 0.0642 | 0.0952 |
| 979 | 0.0608 | 0.0964 |
| 980 | 0.0616 | 0.0977 |
| 981 | 0.0673 | 0.099 |
| 982 | 0.0618 | 0.1001 |
| 983 | 0.0642 | 0.0933 |
| 984 | 0.0651 | 0.0965 |
| 985 | 0.066 | 0.1031 |
| 986 | 0.067 | 0.0979 |
| 987 | 0.0635 | 0.0987 |
| 988 | 0.0649 | 0.0984 |
| 989 | 0.0701 | 0.0999 |
| 990 | 0.068 | 0.1032 |
| 991 | 0.0671 | 0.0995 |
| 992 | 0.0677 | 0.0984 |
| 993 | 0.0656 | 0.1005 |
| 994 | 0.0676 | 0.1074 |
| 995 | 0.0703 | 0.1015 |
| 996 | 0.0671 | 0.102 |
| 997 | 0.0639 | 0.0997 |
| 998 | 0.0695 | 0.1088 |
| 999 | 0.0706 | 0.1088 |
| 1000 | 0.0718 | 0.1046 |
| 1001 | 0.0619 | 0.1024 |
| 1002 | 0.0707 | 0.0972 |
| 1003 | 0.072 | 0.1038 |
| 1004 | 0.0708 | 0.1067 |
| 1005 | 0.0714 | 0.1068 |
| 1006 | 0.0687 | 0.1013 |
| 1007 | 0.0711 | \|0.1003 |
| 1008 | 0.0693 | 0.1146 |
| 1009 | 0.0706 | 0.1091 |
| 1010 | 0.0719 | 0.1063 |
| 1011 | 0.0733 | 0.1035 |
| 1012 | 0.0749 | 0.1098 |
| 1013 | 0.0695 | 0.1116 |
| 1014 | 0.0714 | 0.1077 |
| 1015 | 0.0765 | 0.1102 |
| 1016 | 0.0732 | 0.1063 |
| 1017 | 0.0747 | 0.121 |
| 1018 | 0.0685 | 0.1093 |
| 1019 | 0.0751 | 0.1118 |
| 1020 | 0.0707 | 0.1078 |
| 1021 | 0.0724 | 0.1084 |
| 1022 | 0.0741 | 0.113 |
| 1023 | 0.0755 | 0.118 |
| 1024 | 0.0816 | 0.1101 |
| 1025 | 0.0821 | 0.1096 |
| 1026 | 0.072 | 0.1118 |
| 1027 | 0.0724 | 0.1147 |
| 1028 | 0.0782 | 0.1175 |
| 1029 | 0.0802 | 0.1035 |
| 1030 | 0.0873 | 0.1133 |
| 1031 | 0.08 | 0.1158 |
| 1032 | 0.0782 | 0.1183 |
| 1033 | 0.0717 | 0.1133 |
| 1034 | 0.0736 | 0.1024 |
| 1035 | 0.0759 | 0.1073 |
| 1036 | 0.0776 | 0.1195 |
| 1037 | 0.0795 | 0.1223 |
| 1038 | 0.0816 | 0.0912 |
| 1039 | 0.0838 | 0.1163 |
| 1040 | 0.0721 | 0.1189 |
| 1041 | 0.074 | 0.122 |
| 1042 | 0.0667 | 0.1144 |
| 1043 | 0.0752 | 0.1005 |
| 1044 | 0.0802 | 0.1035 |
| 1045 | 0.0825 | 0.1146 |
| 1046 | 0.0846 | 0.1243 |
| 1047 | 0.0738 | 0.0963 |
| 1048 | 0.0894 | 0.1033 |
| 1049 | 0.078 | 0.119 |
| 1050 | 0.0864 | 0.1222 |

### 2nd Embodiment

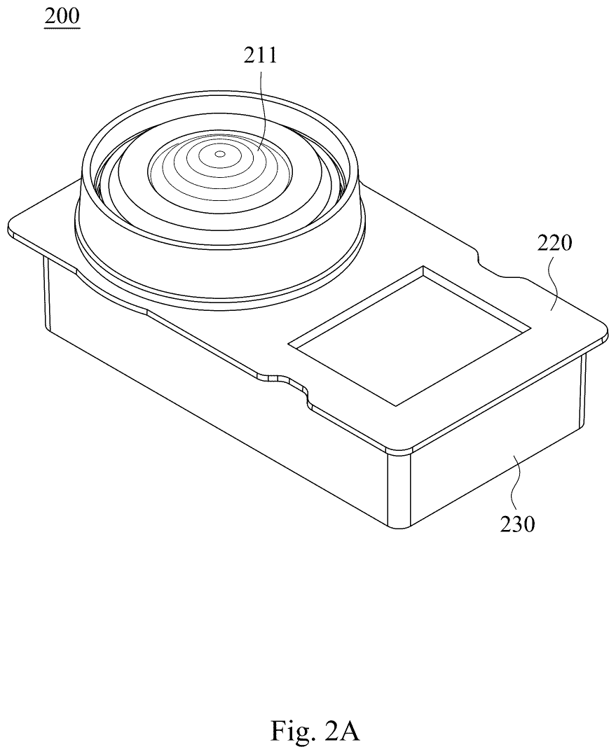

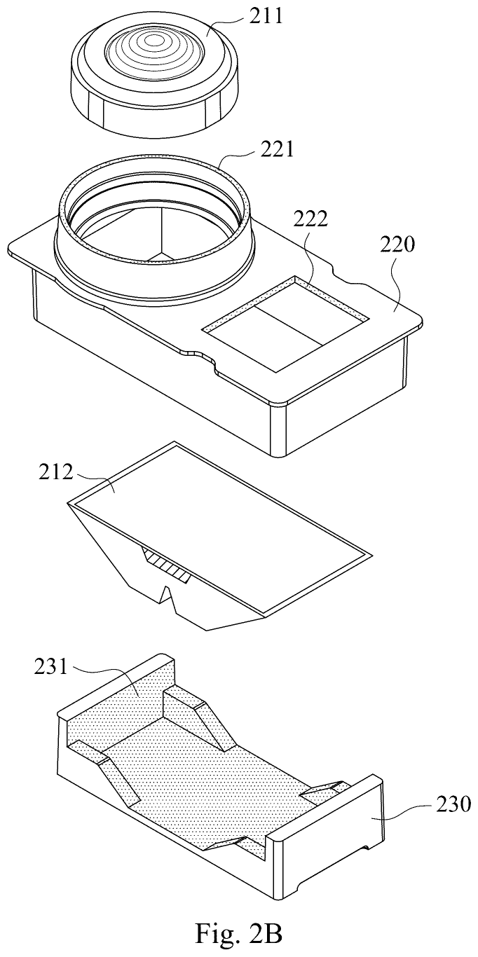

FIG. 2A is a schematic view of an imaging lens assembly module 200 according to the 2nd Embodiment of the present disclosure, and FIG. 2B is an exploded view of the imaging lens assembly module 200 according to the 2nd Embodiment in FIG. 2A. In FIG. 2A and FIG. 2B, the structures, positions and connection relationships of elements according to the 2nd Embodiment are the same as or similar to the structures, positions and connection relationships of elements according to the 1st Embodiment, the difference is that the imaging lens assembly module 200 according to the 2nd Embodiment includes two optical elements 211, 212 and two light-blocking elements 220, 230, the light-blocking element 220 is disposed corresponding to the optical elements 211, 212, and the light-blocking element 230 is disposed corresponding to the optical element 212. The light-blocking element 220 includes two low reflective cluster layers 221, 222, and the low reflective cluster layers 221, 222 are disposed on surfaces (its reference numeral is omitted) of the light-blocking element 220. Specifically, a low reflective cluster layer 231 of the light-blocking element 230 and the low reflective cluster layer 222 of the light-blocking element 220 correspond to the optical element 212, and the low reflective cluster layer 221 of the light-blocking element 220 corresponds to the optical element 211. In detail, the optical element 211, the light-blocking element 220, the optical element 212 and the light-blocking element 230 are arranged in order. Moreover, the optical element 211 can be an imaging lens assembly, the light-blocking element 220 can be an imaging lens assembly carrier configured to carry the optical element 211, the optical element 212 can be a light folding element, and the light-blocking element 230 can be a base configured to accommodate the optical element 212, but the present disclosure is not limited thereto.

Furthermore, a composition of at least one of the low reflective cluster layers 221, 222, 231 includes a metallic element and a fluorine, and the composition of at least one of the low reflective cluster layers 221, 222, 231 includes a metallic element and an oxygen. Further, the low reflective cluster layers 221, 222, 231 can further include a carbon. Moreover, the low reflective cluster layers 221, 222, 231 can further include a silicon.

Specifically, the composition of the at least one of the low reflective cluster layers 221, 222, 231 includes the metallic element and the oxygen, which can be regarded as including the metal oxide, but is not limited thereto, wherein the metal oxide can be Al₂O₃, Cr₂O₃, Ta₂O₅, SnO₂, Sb₂O₅, CeO₂, Ag₂O, Y₂O₃, ZrO₂, HfO₂, Yb₂O₃, In₂O₃, RuO₂, CuO, FeO, ZnO, BeO, etc., but is not limited to the listed compounds. Moreover, the composition of the at least one of the low reflective cluster layers 221, 222, 231 includes the metallic element and the fluorine, which can be regarded as including the metal fluoride, but is not limited thereto, wherein the metal fluoride can be MgF₂, AlF₃, BaF₂, Na₅AlF₆, Na₅Al₃F₁₄, YF₃, etc., but is not limited to the listed compounds.

The configurations, structures and arrangements of the other elements according to the 2nd Embodiment are the same as the configurations, structures and arrangements of the other elements according to the 1st Embodiment, and will not describe again herein.

### 3rd Embodiment

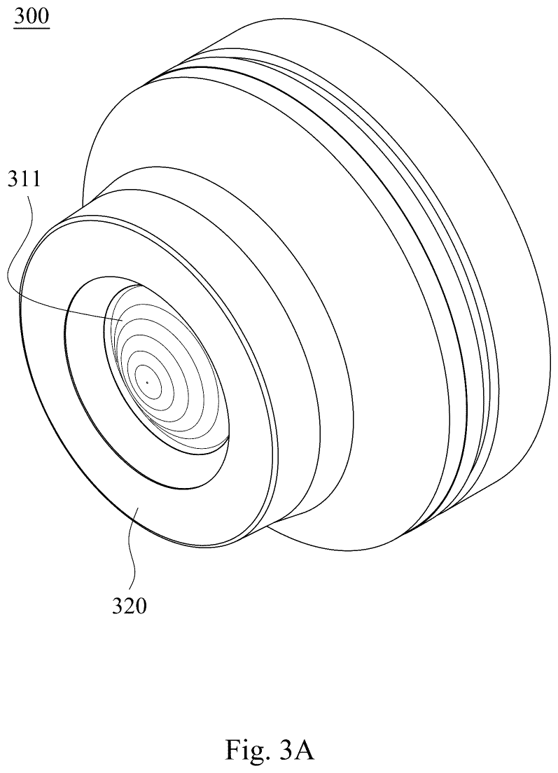

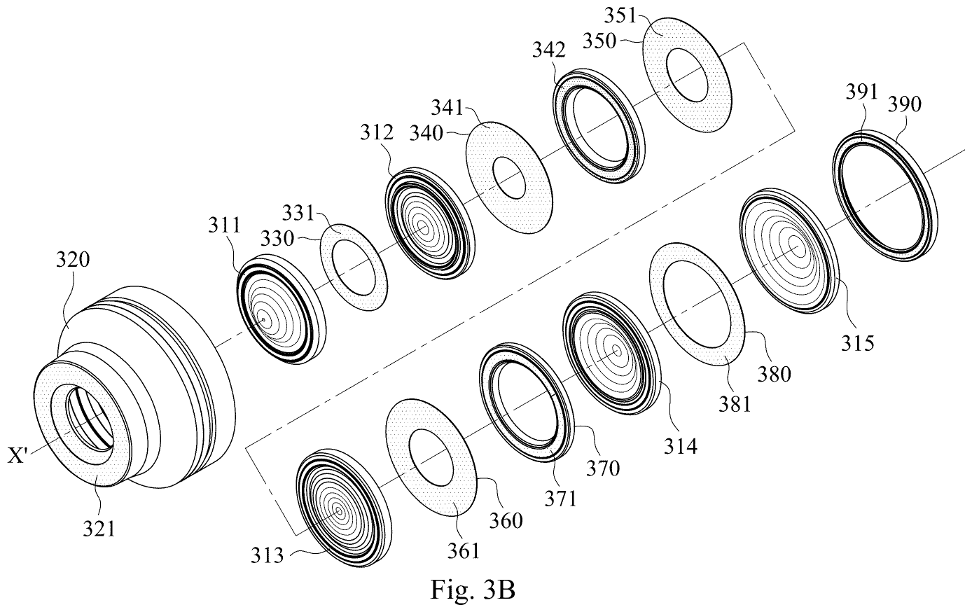

FIG. 3A is a schematic view of an imaging lens assembly module 300 according to the 3rd Embodiment of the present disclosure, and FIG. 3B is an exploded view of the imaging lens assembly module 300 according to the 3rd Embodiment in FIG. 3A. In FIG. 3A and FIG. 3B, the structures, positions and connection relationships of elements according to the 3rd Embodiment are the same as or similar to the structures, positions and connection relationships of elements according to the 1st Embodiment, the difference is that the imaging lens assembly module 300 according to the 3rd Embodiment includes five optical elements 311, 312, 313, 314, 315 and nine light-blocking elements 320, 330, 340, 342, 350, 360, 370, 380, 390, the light-blocking element 320 is disposed corresponding to the optical element 311, the light-blocking element 330 is disposed corresponding to the optical elements 311, 312, the light-blocking element 340 is disposed corresponding to the optical element 312, the light-blocking elements 350, 360 are disposed corresponding to the optical element 313, the light-blocking elements 370, 380 are disposed corresponding to the optical element 314, and the light-blocking elements 380, 390 are disposed corresponding to the optical element 315. Moreover, the light-blocking element 320 includes a low reflective cluster layer 321, the light-blocking element 330 includes a low reflective cluster layer 331, the light-blocking element 340 includes a low reflective cluster layer 341, the light-blocking element 350 includes a low reflective cluster layer 351, the light-blocking element 360 includes a low reflective cluster layer 361, the light-blocking element 370 includes a low reflective cluster layer 371, the light-blocking element 380 includes a low reflective cluster layer 381, and the light-blocking element 390 includes a low reflective cluster layer 391. Further, the low reflective cluster layer 321 is disposed on a surface (its reference numeral is omitted) of the light-blocking element 320. In detail, the light-blocking element 320, the optical element 311, the light-blocking element 330, the optical element 312, the light-blocking element 340, the light-blocking element 342, the light-blocking element 350, the optical element 313, the light-blocking element 360, the light-blocking element 370, the optical element 314, the light-blocking element 380, the optical element 315 and the light-blocking element 390 are arranged in order along a central axis X′ of the imaging lens assembly module 300.

Specifically, the optical elements 311, 312, 313, 314, 315 can be lens elements and have the central axis X′, the light-blocking element 320 can be a barrel, the light-blocking elements 330, 340, 350, 360, 380 can be light blocking members, the light-blocking elements 342, 370 can be spacers, and the light-blocking element 390 can be a retainer, wherein the optical elements 311, 312, 313, 314, 315 are accommodated in the light-blocking element 320. Further, the light-blocking element 390 is configured to fix the light-blocking element 320, the optical element 311, the light-blocking element 330, the optical element 312, the light-blocking element 340, the light-blocking element 342, the light-blocking element 350, the optical element 313, the light-blocking element 360, the light-blocking element 370, the optical element 314, the light-blocking element 380 and the optical element 315.

Furthermore, a composition of at least one of the low reflective cluster layers 321, 331, 341, 351, 361, 371, 381, 391 includes a metallic element and a fluorine, and the composition of at least one of the low reflective cluster layers 321, 331, 341, 351, 361, 371, 381, 391 includes a metallic element and an oxygen. Further, the composition of the low reflective cluster layers 321, 331, 341, 351, 361, 371, 381, 391 can further include a carbon. Moreover, the composition of the low reflective cluster layers 321, 331, 341, 351, 361, 371, 381, 391 can further include a silicon.

Specifically, the composition of the at least one of the low reflective cluster layers 321, 331, 341, 351, 361, 371, 381, 391 includes the metallic element and the oxygen, which can be regarded as including the metal oxide, but is not limited thereto, wherein the metal oxide can be Al₂O₃, Cr₂O₃, Ta₂O₅, SnO₂, Sb₂O₅, CeO₂, Ag₂O, Y₂O₃, ZrO₂, HfO₂, Yb₂O₃, In₂O₃, RuO₂, CuO, FeO, ZnO, BeO, etc., but is not limited to the listed compounds. Moreover, the composition of the at least one of the low reflective cluster layers 321, 331, 341, 351, 361, 371, 381, 391 includes the metallic element and the fluorine, which can be regarded as including the metal fluoride, but is not limited thereto, wherein the metal fluoride can be MgF₂, AlF₃, BaF₂, Na₅AlF₆, Na₅Al₃F₁₄, YF₃, etc., but is not limited to the listed compounds.

The configurations, structures and arrangements of the other elements according to the 3rd Embodiment are the same as the configurations, structures and arrangements of the other elements according to the 1st Embodiment, and will not describe again herein.

### 4th Embodiment

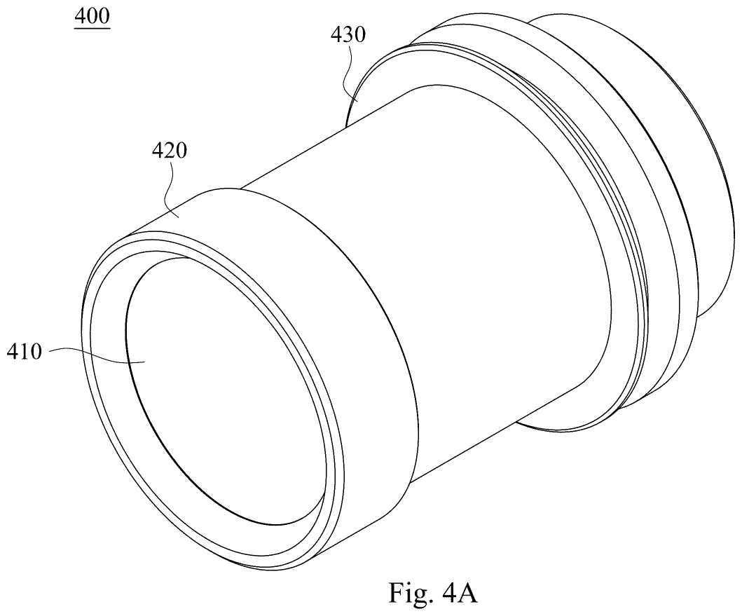

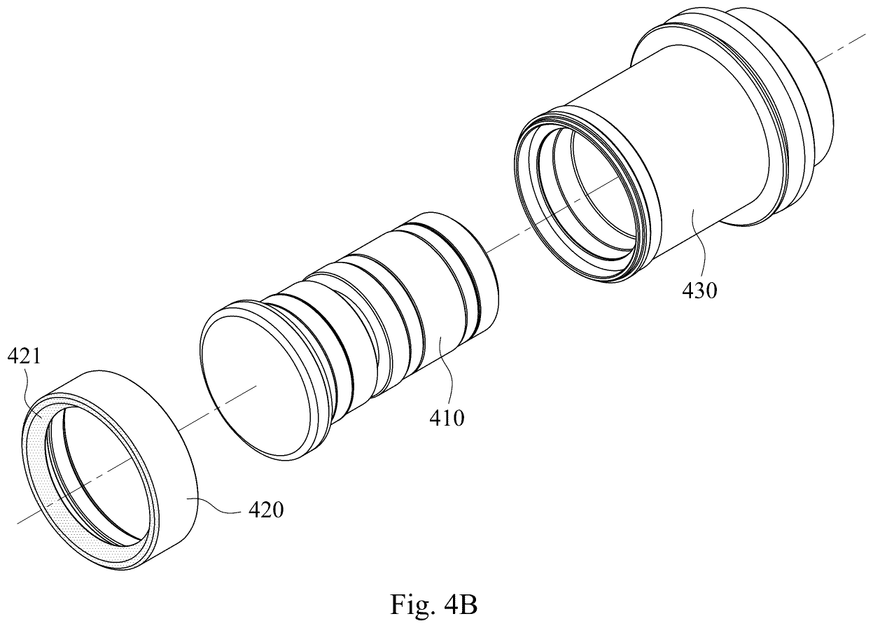

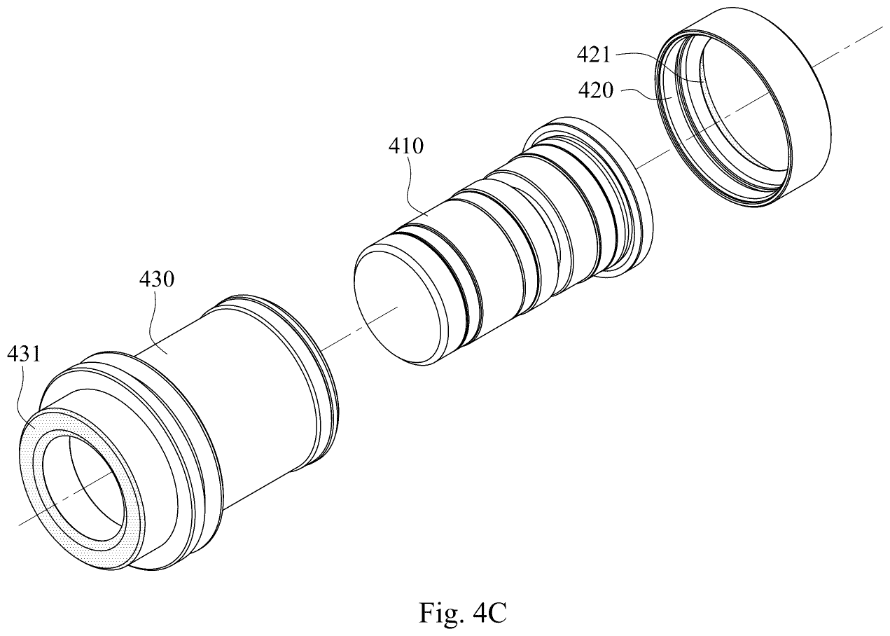

FIG. 4A is a schematic view of an imaging lens assembly module 400 according to the 4th Embodiment of the present disclosure, FIG. 4B is an exploded view of the imaging lens assembly module 400 according to the 4th Embodiment in FIG. 4A, and FIG. 4C is another exploded view of the imaging lens assembly module 400 according to the 4th Embodiment in FIG. 4A. In FIG. 4A to FIG. 4C, the structures, positions and connection relationships of elements according to the 4th Embodiment are the same as or similar to the structures, positions and connection relationships of elements according to the 1st Embodiment, the difference is that the imaging lens assembly module 400 according to the 4th Embodiment includes an optical element 410 and two light-blocking elements 420, 430, the light-blocking elements 420, 430 are respectively disposed corresponding to the optical element 410. The light-blocking elements 420, 430 respectively include low reflective cluster layers 421, 431, and the low reflective cluster layers 421, 431 are respectively disposed on surfaces of the light-blocking elements 420, 430. In detail, the light-blocking element 430, the optical element 410, and the light-blocking element 420 are arranged in order. Further, the optical element 410 can be a lens element, the light-blocking element 420 can be a retainer and can be a metal element, and the light-blocking element 430 can be a barrel and can be a plastic element.

Moreover, a composition of at least one of the low reflective cluster layers 421, 431 includes a metallic element and a fluorine, and the composition of at least one of the low reflective cluster layers 421, 431 includes a metallic element and an oxygen. Further, the composition of the low reflective cluster layers 421, 431 can further include a carbon. Moreover, the composition of the low reflective cluster layers 421, 431 can further include a silicon.

Specifically, the composition of the at least one of the low reflective cluster layers 421, 431 includes the metallic element and the oxygen, which can be regarded as including the metal oxide, but is not limited thereto, wherein the metal oxide can be Al₂O₃, Cr₂O₃, Ta₂O₅, SnO₂, Sb₂O₅, CeO₂, Ag₂O, Y₂O₃, ZrO₂, HfO₂, Yb₂O₃, In₂O₃, RuO₂, CuO, FeO, ZnO, BeO, etc., but is not limited to the listed compounds. Moreover, the composition of the at least one of the low reflective cluster layers 421, 431 includes the metallic element and the fluorine, which can be regarded as including the metal fluoride, but is not limited thereto, wherein the metal fluoride can be MgF₂, AlF₃, BaF₂, Na₅AlF₆, Na₅Al₃F₁₄, YF₃, etc., but is not limited to the listed compounds.

The configurations, structures and arrangements of the other elements according to the 4th Embodiment are the same as the configurations, structures and arrangements of the other elements according to the 1st Embodiment, and will not describe again herein.

### 5th Embodiment

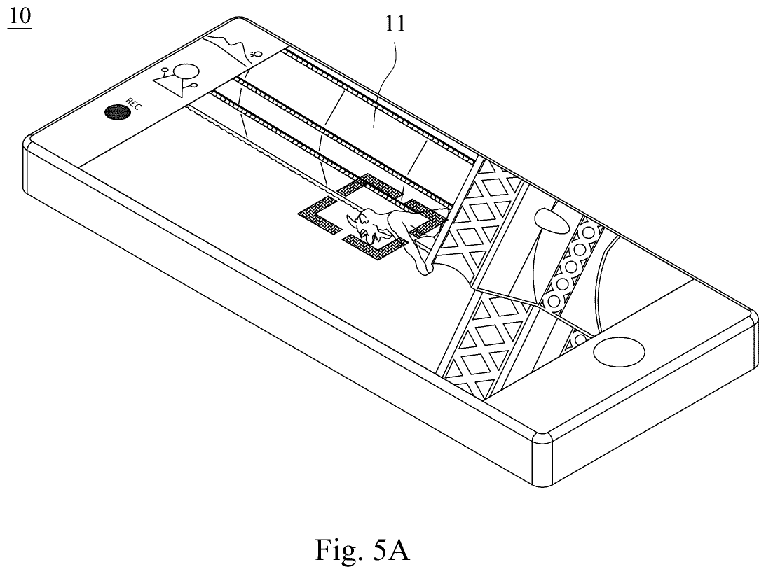

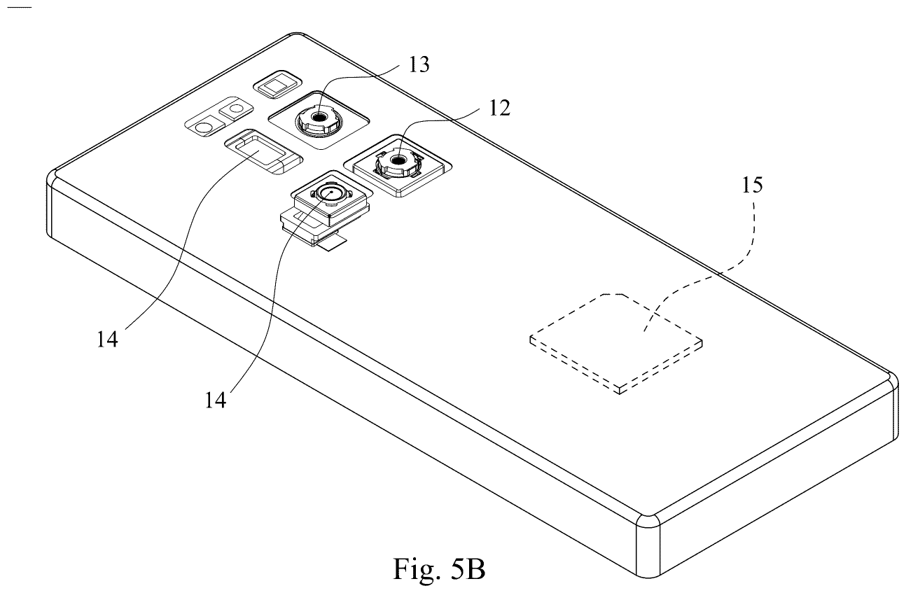

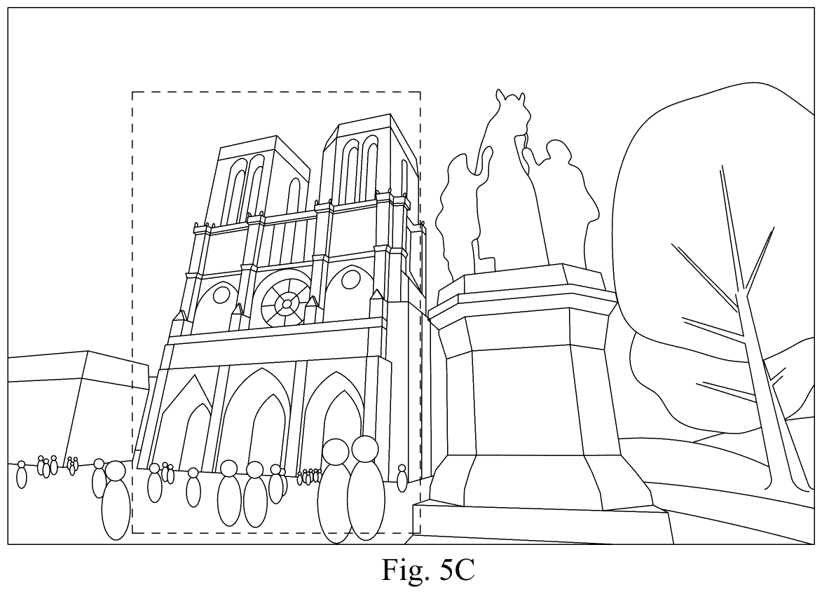

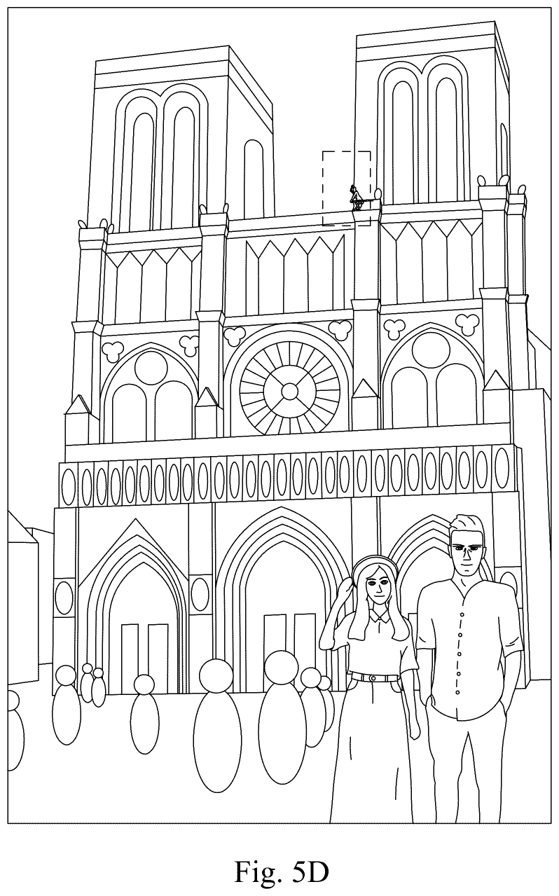

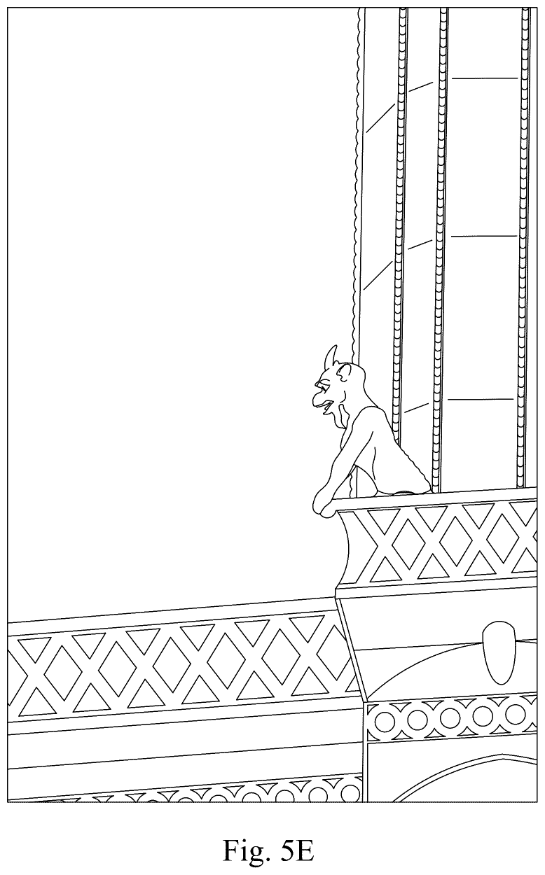

FIG. 5A is a schematic view of an electronic device 10 according to the 5th Embodiment of the present disclosure, and FIG. 5B is another schematic view of the electronic device 10 according to the 5th Embodiment in FIG. 5A. In FIG. 5A and FIG. 5B, the electronic device 10 is a smart phone, and the electronic device 10 includes imaging lens assembly modules and a user interface 11. Moreover, the imaging lens assembly modules are an ultra-wide angle imaging lens assembly module 12, a high resolution imaging lens assembly module 13 and a telephoto imaging lens assembly module 14, and the user interface 11 is a touch screen, but the present disclosure is not limited thereto. Particularly, the imaging lens assembly module can be the imaging lens assembly module according to any one of the imaging lens assembly modules according to the aforementioned 1st Embodiment to the 4th Embodiment, but the present disclosure is not limited thereto.

A user enters a shooting mode via the user interface 11, wherein the user interface 11 is configured to display an image, and the shooting angle can be manually adjusted to switch to different imaging lens assembly modules. At this moment, the imaging light is gathered on an image sensor of the electronic device 10, and an electronic signal about an image is output to an image signal processor (ISP) 15.

In FIG. 5B, in order to meet a camera specification of the electronic device 10, the electronic device 10 can further include an optical anti-shake mechanism (not shown). Furthermore, the electronic device 10 can further include at least one focusing assisting module (not shown) and at least one sensing element (not shown). The focusing assisting module can be a flash module (not shown) for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly module of the electronic device 10 equipped with an auto-focusing mechanism and the optical anti-shake mechanism can be enhanced to achieve the superior image quality. Furthermore, the electronic device 10 according to the present disclosure can have a capturing function with multiple modes, such as taking optimized selfies, high dynamic range (HDR) under a low light condition, 4K resolution recording and so on. Furthermore, the user can visually see a captured image of the camera via the user interface 11 and manually operate the view finding range on the user interface 11 to achieve the autofocus function of what you see is what you get.

Moreover, the imaging lens assembly module, the optical anti-shake mechanism, the sensing element and the focusing assisting module can be disposed on a flexible printed circuit board (FPC) (not shown) and electrically connected to the image signal processor 15 and other related components, via a connector (not shown) to perform a capturing process. Since the current electronic devices, such as smart phones, have a tendency of being compact, the way of firstly disposing the imaging lens assembly module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the imaging lens assembly module can also be controlled more flexibly via the touch screen of the electronic device. According to the 5th Embodiment, the electronic device 10 can include a plurality of sensing elements and a plurality of focusing assisting modules. The sensing elements and the focusing assisting modules are disposed on the flexible printed circuit board and at least one other flexible printed circuit board (not shown) and electrically connected to the image signal processor 15 and other related components, via corresponding connectors to perform the capturing process. In other embodiments (not shown), the sensing elements and the focusing assisting modules can also be disposed on the main board of the electronic device or carrier boards of other types according to requirements of the mechanical design and the circuit layout.

Furthermore, the electronic device 10 can further include, but not be limited to, a display, a control unit, a storage unit, a random access memory (RAM), a read-only memory (ROM), or the combination thereof.

FIG. 5C is a schematic view of an image captured via the electronic device 10 according to the 5th Embodiment in FIG. 5A. In FIG. 5C, the larger range of the image can be captured via the ultra-wide angle imaging lens assembly module 12, and the ultra-wide angle imaging lens assembly module 12 has the function of accommodating wider range of the scene.

FIG. 5D is a schematic view of another image captured via the electronic device 10 according to the 5th Embodiment in FIG. 5A. In FIG. 5D, the image of the certain range with the high resolution can be captured via the high resolution imaging lens assembly module 13, and the high resolution imaging lens assembly module 13 has the function of the high resolution and the low deformation.

FIG. 5E is a schematic view of another image captured via the electronic device 10 according to the 5th Embodiment in FIG. 5A. In FIG. 5E, the telephoto imaging lens assembly module 14 has the enlarging function of the high magnification, and the distant image can be captured and enlarged with high magnification via the telephoto imaging lens assembly module 14.

In FIG. 5C to FIG. 5E, the zooming function can be obtained via the electronic device 10, when the scene is captured via the imaging lens assembly modules with different focal lengths cooperated with the function of image processing.

### 6th Embodiment

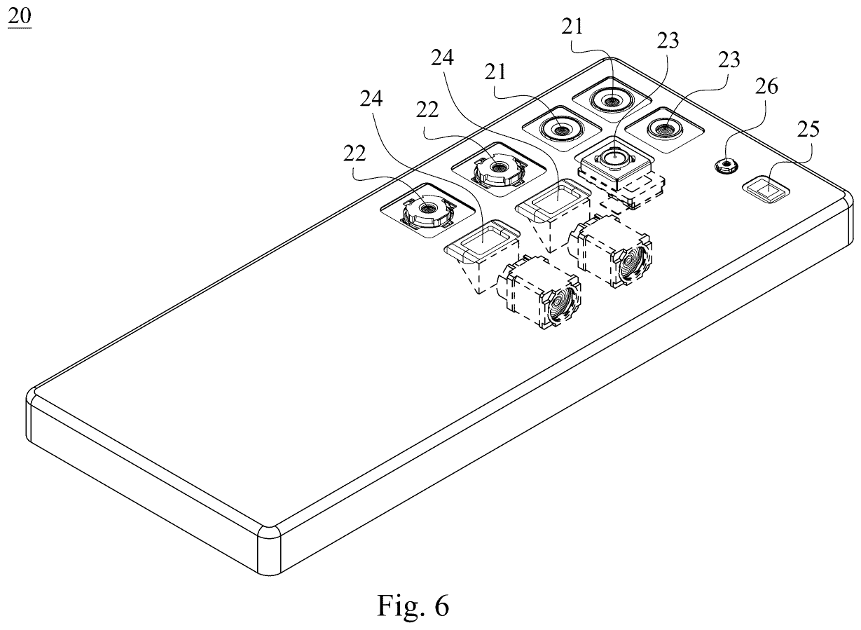

FIG. 6 is a schematic view of an electronic device 20 according to the 6th Embodiment of the present disclosure. In FIG. 6, the electronic device 20 is a smart phone, and the electronic device 20 includes imaging lens assembly modules. Moreover, the imaging lens assembly modules are ultra-wide angle imaging lens assembly modules 21, wide angle imaging lens assembly modules 22, telephoto imaging lens assembly modules 23, 24 and a Time-Of-Flight (TOF) module 26. The TOF module 26 can be another type of the imaging lens assembly module, and the disposition is not limited thereto. Particularly, the imaging lens assembly module can be the imaging lens assembly module according to any one of the imaging lens assembly modules according to the aforementioned 1st Embodiment to the 4th Embodiment, but the present disclosure is not limited thereto.

Furthermore, the telephoto imaging lens assembly modules 24 are configured to fold the light, but the present disclosure is not limited thereto.

To meet a specification of the camera module of the electronic device 20, the electronic device 20 can further include an optical anti-shake mechanism (not shown). Furthermore, the electronic device 20 can further include at least one focusing assisting module (not shown) and at least one sensing element (not shown). The focusing assisting module can be a flash module 25 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the imaging lens assembly module of the electronic device 20 equipped with an auto-focusing mechanism and the optical anti-shake mechanism can be enhanced to achieve the superior image quality. Furthermore, the electronic device 20 according to the present disclosure can have a capturing function with multiple modes, such as taking optimized selfies, High Dynamic Range (HDR) under a low light condition, 4K Resolution recording and so on.

Moreover, all of other component structures and dispositions according to the 6th Embodiment are the same as the component structures and the dispositions according to the 5th Embodiment, and will not be described again herein.

### 7th Embodiment

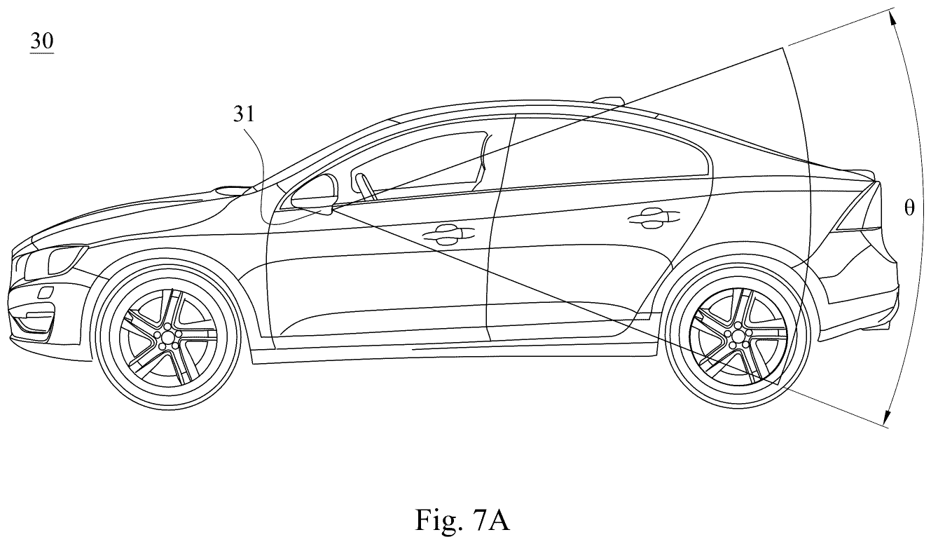

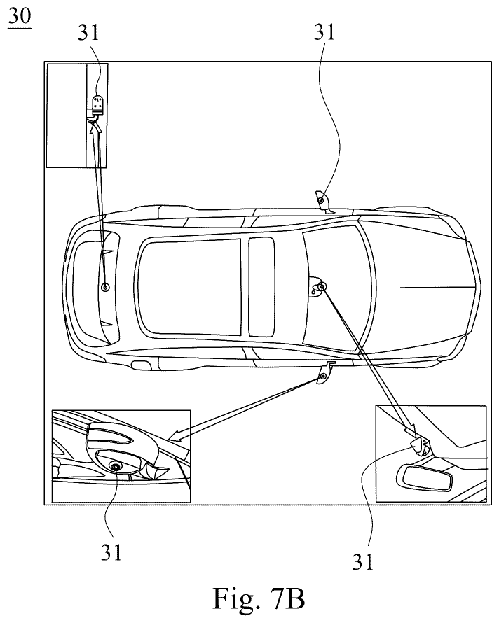

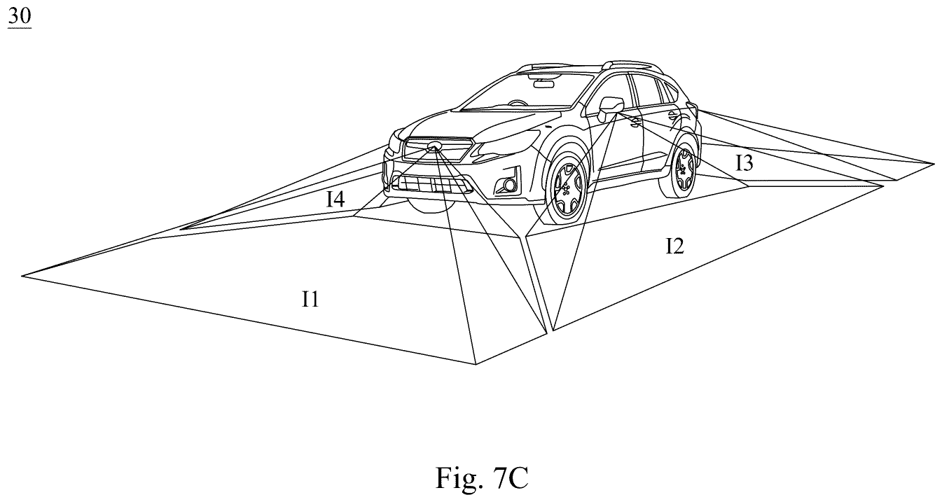

FIG. 7A is a schematic view of an electronic device configured on a vehicle 30 according to the 7th Embodiment of the present disclosure, FIG. 7B is another schematic view of the electronic device configured on the vehicle 30 according to the 7th Embodiment in FIG. 7A, and FIG. 7C is another schematic view of the electronic device configured on the vehicle 30 according to the 7th Embodiment in FIG. 7A. In FIG. 7A to FIG. 7C, the electronic device (its reference numeral is omitted) is applied to the vehicle 30, and the electronic device includes imaging lens assembly modules 31. In the 7th Embodiment, a number of the imaging lens assembly modules 31 is six, the imaging lens assembly modules 31 are vehicle imaging lens assembly modules. Specifically, the imaging lens assembly module can be the imaging lens assembly module according to any one of the imaging lens assembly modules according to the aforementioned 1st Embodiment to the 4th Embodiment, but the present disclosure is not limited thereto.

In FIG. 7A to FIG. 7C, two of imaging lens assembly modules 31 are disposed below a left rearview mirror and a right rearview mirror, respectively, to capture the image information with a visual angle θ. Particularly, the visual angle θ can satisfy the following condition 40 degrees<θ<90 degrees. Therefore, the image information within a left lane and a right lane can be captured.

In FIG. 7A to FIG. 7C, another two of the imaging lens assembly modules 31 can be disposed in an inner space of the vehicle 30. Particularly, the another two of imaging lens assembly modules 31 are disposed near a rearview mirror and near a rear window in the vehicle 30 respectively. Moreover, the imaging lens assembly modules 31 can be disposed on the non-mirror surfaces of the left rearview mirror and the right rearview mirror of the vehicle 30, respectively, but the present disclosure is not limited thereto.

The other two of the imaging lens assembly modules 31 can be disposed at a front-end and a rear-end of the vehicle 30, respectively, wherein the imaging lens assembly modules 31 are disposed at a front-end and a rear-end of the vehicle 30, and below the left rearview mirror and the right rearview mirror. It is favorable to a driver to obtain the information of the outer space, such as external space information 11, 12, 13, 14, but the present disclosure is not limited thereto. Therefore, more visual angles can be provided to reduce the blind spot, so that the driving safety can be improved. Moreover, it is helpful to identify the traffic information out of the vehicle 30 via disposing the imaging lens assembly modules 31 around the vehicle 30, which is favorable for realizing a function of autopilot driving.

### 8th Embodiment

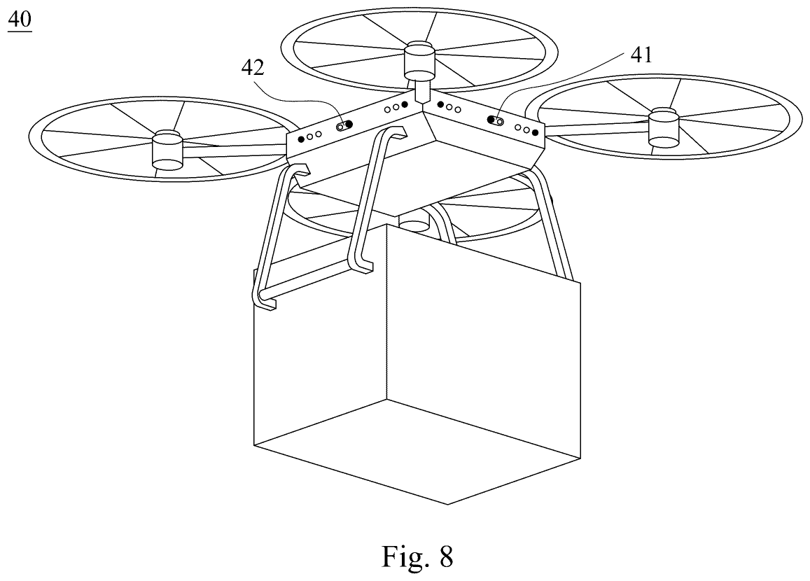

FIG. 8 is a schematic view of an electronic device applied to an unmanned aerial vehicle 40 according to the 8th Embodiment of the present disclosure. In FIG. 8, the electronic device includes imaging lens assembly modules. Moreover, the imaging lens assembly module can be any one of the imaging lens assembly modules according to the aforementioned 1st Embodiment to the 4th Embodiment, but the present disclosure is not limited thereto.

In the 8th Embodiment, the imaging lens assembly modules are a front camera module 41 and a lateral camera module 42, respectively.

Specifically, the front camera module 41 is disposed on a front end of the unmanned aerial vehicle 40, and the lateral camera module 42 is disposed on a side of the unmanned aerial vehicle 40. Therefore, the electronic device can be configured to cope with the complicated environmental light.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly module, comprising:
at least one lens element having a central axis; and
a barrel, wherein the at least one lens element is accommodated in the barrel, and the barrel comprises:
a low reflective cluster layer disposed on a surface of the barrel;
wherein a composition of the low reflective cluster layer comprises a metallic element and a fluorine, an average particle size of the low reflective cluster layer is φavg, a reflectance of the low reflective cluster layer at a wavelength of 550 nm is R55, a reflectance of the low reflective cluster layer at a wavelength of 700 nm is R70, and the following conditions are satisfied:
$$\begin{matrix}20 nm \leq {ϕ}_{avg} \leq 180 nm ; \\ R 55 \leq 0.25 \% ; and \\ R 70 \leq 0.25 \% .\end{matrix}$$

2. The imaging lens assembly module of claim 1, wherein the average particle size of the low reflective cluster layer is φavg, and the following condition is satisfied:
$$50 nm \leq {ϕ}_{avg} \leq 170 nm .$$

3. The imaging lens assembly module of claim 1, wherein an average reflectance of the low reflective cluster layer within a wavelength range of 400 nm to 500 nm is R4050, and the following condition is satisfied:
$$R 4050 \leq 0.25 \% .$$

4. The imaging lens assembly module of claim 3, wherein the average reflectance of the low reflective cluster layer within the wavelength range of 400 nm to 500 nm is R4050, and the following condition is satisfied:
$$R 4050 \leq 0.13 \% .$$

5. The imaging lens assembly module of claim 1, wherein the reflectance of the low reflective cluster layer at the wavelength of 550 nm is R55, the reflectance of the low reflective cluster layer at the wavelength of 700 nm is R70, and the following conditions are satisfied:
$$R 55 \leq 0.13 \% ; and$$
$$R 70 \leq 0.13 \% .$$

6. The imaging lens assembly module of claim 5, wherein the reflectance of the low reflective cluster layer at the wavelength of 550 nm is R55, the reflectance of the low reflective cluster layer at the wavelength of 700 nm is R70, and the following conditions are satisfied:
$$R 55 \leq 0.07 \% ; and$$
$$R 70 \leq 0.07 \% .$$

7. The imaging lens assembly module of claim 1, wherein the composition of the low reflective cluster layer further comprises a silicon.

8. The imaging lens assembly module of claim 7, wherein the composition of the low reflective cluster layer further comprises silicon dioxide.

9. The imaging lens assembly module of claim 1, wherein the composition of the low reflective cluster layer further comprises a carbon and a metal fluoride.

10. The imaging lens assembly module of claim 9, wherein the composition of the low reflective cluster layer further comprises magnesium fluoride.

11. A camera module, comprising:
the imaging lens assembly module of claim 1.

12. An electronic device, comprising:
the camera module of claim 11.

13. An imaging lens assembly module, comprising:
at least one optical element; and
a light-blocking element disposed corresponding to the at least one optical element, wherein the light-blocking element comprises:
a low reflective cluster layer disposed on a surface of the light-blocking element;
wherein a composition of the low reflective cluster layer comprises a metallic element and a fluorine, an average particle size of the low reflective cluster layer is φavg, a reflectance of the low reflective cluster layer at a wavelength of 550 nm is R55, a reflectance of the low reflective cluster layer at a wavelength of 700 nm is R70, and the following conditions are satisfied:
$$20 nm \leq Φ avg \leq 180 nm ;$$
$$R 55 \leq 0.25 \% ; and$$
$$R 70 \leq 0.25 \% .$$

14. The imaging lens assembly module of claim 13, wherein the average particle size of the low reflective cluster layer is φavg, and the following condition is satisfied:
$$50 nm \leq Φ avg \leq 170 nm .$$

15. The imaging lens assembly module of claim 13, wherein an average reflectance of the low reflective cluster layer within a wavelength range of 400 nm to 500 nm is R4050, and the following condition is satisfied:
$$R 4050 \leq 0.25 \% .$$

16. The imaging lens assembly module of claim 15, wherein the average reflectance of the low reflective cluster layer within the wavelength range of 400 nm to 500 nm is R4050, and the following condition is satisfied:
$$R 4050 \leq 0.13 \% .$$

17. The imaging lens assembly module of claim 13, wherein the reflectance of the low reflective cluster layer at the wavelength of 550 nm is R55, the reflectance of the low reflective cluster layer at the wavelength of 700 nm is R70, and the following conditions are satisfied:
$$R 55 \leq 0.13 \% ; and$$
$$R 70 \leq 0.13 \% .$$

18. The imaging lens assembly module of claim 17, wherein the reflectance of the low reflective cluster layer at the wavelength of 550 nm is R55, the reflectance of the low reflective cluster layer at the wavelength of 700 nm is R70, and the following conditions are satisfied:
$$R 55 \leq 0.07 \% ; and$$
$$R 70 \leq 0.07 \% .$$

19. The imaging lens assembly module of claim 13, wherein the composition of the low reflective cluster layer further comprises a silicon.

20. The imaging lens assembly module of claim 19, wherein the composition of the low reflective cluster layer further comprises silicon dioxide.

21. The imaging lens assembly module of claim 13, wherein the composition of the low reflective cluster layer further comprises a carbon and a metal fluoride.

22. The imaging lens assembly module of claim 21, wherein the composition of the low reflective cluster layer further comprises magnesium fluoride.

23. A camera module, comprising:
the imaging lens assembly module of claim 13.

24. An electronic device, comprising:
the camera module of claim 23.

25. An imaging lens assembly module, comprising:
at least one optical element; and
a light-blocking element disposed corresponding to the at least one optical element, wherein the light-blocking element comprises:
a low reflective cluster layer disposed on a surface of the light-blocking element;
wherein a composition of the low reflective cluster layer comprises a metallic element and an oxygen, an average particle size of the low reflective cluster layer is avg, a reflectance of the low reflective cluster layer at a wavelength of 550 nm is R55, a reflectance of the low reflective cluster layer at a wavelength of 700 nm is R70, and the following conditions are satisfied:
$$20 nm \leq Φ avg \leq 180 nm ;$$
$$R 55 \leq 0.25 \% ; and$$
$$R 70 \leq 0.25 \% .$$

26. The imaging lens assembly module of claim 25, wherein the average particle size of the low reflective cluster layer is φavg, and the following condition is satisfied:
$$50 nm \leq Φ avg \leq 170 nm .$$

27. The imaging lens assembly module of claim 25, wherein an average reflectance of the low reflective cluster layer within a wavelength range of 400 nm to 500 nm is R4050, and the following condition is satisfied:
$$R 4050 \leq 0.25 \% .$$

28. The imaging lens assembly module of claim 27, wherein the average reflectance of the low reflective cluster layer within the wavelength range of 400 nm to 500 nm is R4050, and the following condition is satisfied:
$$R 4050 \leq 0.13 \% .$$

29. The imaging lens assembly module of claim 25, wherein the reflectance of the low reflective cluster layer at the wavelength of 550 nm is R55, the reflectance of the low reflective cluster layer at the wavelength of 700 nm is R70, and the following conditions are satisfied:
$$R 55 \leq 0.13 \% ; and$$
$$R 70 \leq 0.13 \% .$$

30. The imaging lens assembly module of claim 25, wherein the composition of the low reflective cluster layer further comprises a silicon.

31. The imaging lens assembly module of claim 30, wherein the composition of the low reflective cluster layer further comprises silicon dioxide.

32. The imaging lens assembly module of claim 25, wherein the composition of the low reflective cluster layer further comprises a carbon and a metal oxide.

33. The imaging lens assembly module of claim 32, wherein the composition of the low reflective cluster layer further comprises aluminium oxide.

34. A camera module, comprising:
the imaging lens assembly module of claim 25.

35. An electronic device, comprising:
the camera module of claim 34.
